(19) United States
(12) Patent Application Publication
(10) Pub. No.: US 2025/0004424 A1
(43) Pub. Date: Jan. 2, 2025

(54) WEARABLE DEVICE

(71) Applicant: Huawei Technologies Co., Ltd., Shenzhen (CN)

(72) Inventors: Wei Su, Shenzhen (CN); Qiao Sun, Xi’an (CN); Bing Liu, Xi’an (CN); Kun Li, Xi’an (CN); Mao Ye, Xi’an (CN)

(21) Appl. No.: 18/885,112

(22) Filed: Sep. 13, 2024

Related U.S. Application Data
(63) Continuation of application No. PCT/CN2023/081354, filed on Mar. 14, 2023.

(30) Foreign Application Priority Data
Mar. 17, 2022 (CN) 202210266478.3
Dec. 19, 2022 (CN) 202211633088.1

(51) Int. Cl. G04G 17/04; G04G 21/04; H01Q 1/27

(52) U.S. Cl. CPC G04G 17/04; G04G 21/04; H01Q 1/273

(57) ABSTRACT

A wearable device includes a conductive frame and a parasitic stub. A first ground point and a feed point are disposed on the frame. The parasitic stub has a first slot and a second slot. The parasitic stub and the frame each have a ring shape, and are spaced along a ring circumference. The parasitic stub is divided into a first parasitic part and a second parasitic part with approximately equal lengths by the first slot and the second slot.

### CROSS-REFERENCE TO RELATED APPLICATIONS

This application is a continuation of International Application No. PCT/CN2023/081354, filed on Mar. 14, 2023, which claims priority to Chinese Patent Application No. 202211633088.1, filed on Dec. 19, 2022 and Chinese Patent Application No. 202210266478.3, filed on Mar. 17, 2022. All of the aforementioned patent applications are hereby incorporated by reference in their entireties.

### TECHNICAL FIELD

This application relates to the field of wireless communication, and in particular, to a wearable device.

### BACKGROUND

As mobile communication technologies develop, a wearable device may be configured to monitor important data such as a heartbeat or a sleep status of a human body at any time, and is connected to an internet by using a communication function, to complete data synchronization. Alternatively, the wearable device may obtain information such as weather or a temperature. In addition, with commercial coverage of a BeiDou satellite system communication technology, the wearable device may perform transmission of a short message service message by using a BeiDou satellite system.

An important application of the wearable device cannot be separated from a communication function, and a conventional antenna (which is a BeiDou antenna for short) that supports BeiDou satellite system communication is mainly in a patch form. Consequently, a solution structure is complex and cannot be implemented on the wearable device.

### SUMMARY

Embodiments of this application provide a wearable device. A conductive frame is used as a radiator of an antenna structure, and relative locations of a ground point and a feed point are used, so that maximum radiation directions of radiation patterns generated in different bands are consistent, to meet a requirement for angle alignment.

According to a first aspect, a wearable device is provided. The wearable device includes: a conductive frame, where a first ground point and a feed point are disposed on the frame; and the first ground point is configured to ground the frame; and a parasitic stub, having a first slot and a second slot, where both the parasitic stub and the frame are in a ring shape, and are spaced along a ring circumference; the parasitic stub is divided into a first parasitic part and a second parasitic part by the first slot and the second slot; and a length L4 of the first parasitic part and a length L5 of the second parasitic part meet: (100%−10%)×L4≤L5≤(100%+10%)×L4.

According to the technical solution in this embodiment of this application, a parasitic stub is disposed above a radiator (a frame) of an antenna structure. The parasitic stub may generate an additional resonance by using energy coupled to the parasitic stub when the radiator is resonant, and may be used to extend performance (for example, bandwidth, a gain, and efficiency) of the antenna structure.

With reference to the first aspect, in some implementations of the first aspect, the frame is divided into a first frame part and a second frame part by the first ground point and the feed point, and a length L1 of the first frame part and a length L2 of the second frame part meet: (100%−10%)×L1≤L2≤(100%+10%)×L1.

With reference to the first aspect, in some implementations of the first aspect, a second ground point is further disposed on the frame, and the second ground point is disposed on the first frame part.

According to the technical solution in this embodiment of this application, current distribution of the antenna structure in a first band and a second band may be adjusted by using locations of the first ground point and the feed point. A frequency of the first band is lower than a frequency of the second band. In an embodiment, the first ground point may be disposed between a zero current point generated by the frame in the first band and a zero current point generated by the frame in the second band. Because the ground point is usually a large current point (which increases current intensity at a grounding location), locations of the two zero current points may be changed between the two zero current points generated in the first band and the second band. In this way, a maximum radiation direction of a radiation pattern generated by the antenna structure in the first band is close to a maximum radiation direction of a radiation pattern generated by the antenna structure in the second band. In addition, the second ground point may further make the maximum radiation direction of the radiation pattern generated by the antenna structure in the first band close to the maximum radiation direction of the radiation pattern generated by the antenna structure in the second band. Therefore, the first band and the second band meet a requirement for angle alignment (where for example, an angle difference between the maximum radiation direction of the radiation pattern generated in the first band and the maximum radiation direction of the radiation pattern generated in the second band is less than or equal to) 30°.

With reference to the first aspect, in some implementations of the first aspect, the feed point is configured to feed the frame, and the frame and the parasitic stub are configured to generate radiation in a first band.

According to the technical solution in this embodiment of this application, when a band corresponding to the resonance generated by the parasitic stub is the same as a part of an operating band generated by the radiator, efficiency of the part of the operating band may be improved.

With reference to the first aspect, in some implementations of the first aspect, the frame is further configured to generate radiation in a second band, and a frequency of the first band is lower than a frequency of the second band; and an angle difference between a maximum radiation direction of a radiation pattern generated by the wearable device in the first band and a maximum radiation direction of a radiation pattern generated by the wearable device in the second band is less than or equal to 30°.

According to the technical solution in this embodiment of this application, the angle difference between the maximum radiation direction of the radiation pattern generated by the wearable device in the first band and the maximum radiation direction of the radiation pattern generated by the wearable device in the second band is less than or equal to 30°, to meet the requirement for angle alignment.

With reference to the first aspect, in some implementations of the first aspect, the first band includes a transmit band (for example, an L band, where the L band includes, for example, 1610 MHz to 1626.5 MHz) of a BeiDou satellite system communication band, and the second band includes a receive band (for example, an S band, where the S band includes, for example, 2483.5 MHz to 2500 MHz) of the BeiDou satellite system communication band.

According to the technical solutions in this embodiment of this application, an operating band (an umbrella term for a transmit band and a receive band) of a BeiDou satellite system communication technology may specifically include a B1 (1559 Hz to 1591 MHz) band, a B2 (1166 MHz to 1217 MHz) band, and a B3 (1250 MHz to 1286 MHz) band. For brevity, only the L band (or the transmit band) and the S band (or the receive band) are used as an example for description in this embodiment of this application.

With reference to the first aspect, in some implementations of the first aspect, a length L3 of a third frame part between the first ground point and the second ground point and the length L1 of the first frame part meet: (33%−10%)×L1≤L3≤(33%+10%)×L1, and the first frame part includes the third frame part.

According to the technical solution in this embodiment of this application, when the second ground point is disposed at a location about ⅓ L1 away from the first ground point, at the second ground point, current distribution corresponding to the antenna structure in the first band and the second band may be better adjusted. In this way, the maximum radiation direction of the radiation pattern generated in the first band is close to the maximum radiation direction of the radiation pattern generated in the second band.

With reference to the first aspect, in some implementations of the first aspect, a third slot is provided on the frame, and the third slot is located between the second ground point and the feed point on the first frame part.

According to the technical solution in this embodiment of this application, the third slot is provided on the frame, so that a radiation aperture of the antenna structure may be increased, and efficiency of the antenna structure may be improved.

With reference to the first aspect, in some implementations of the first aspect, on the first frame part, a distance between the third slot and the feed point is within a range of 1 mm to 6 mm.

According to the technical solution in this embodiment of this application, the distance between the third slot and the feed point along the frame may be between 1 mm and 6mm. In an embodiment, the distance between the third slot and the feed point along the frame may be between 2 mm and 5 mm.

With reference to the first aspect, in some implementations of the first aspect, a fourth slot is provided on the first parasitic part; and a projection of the fourth slot on the frame at least partially overlaps a projection of the third slot on the frame.

According to the technical solution in this embodiment of this application, when the parasitic stub generates the resonance, the fourth slot is provided on the parasitic stub, so that impact of a current generated on the parasitic stub on current distribution on the frame may be reduced, and impact on the maximum radiation direction of the radiation pattern generated by the antenna structure may be reduced. A projection location relationship between the fourth slot and the third slot in a first direction may be for adjusting impact of the current generated on the parasitic stub on current distribution on the frame.

With reference to the first aspect, in some implementations of the first aspect, a fourth slot is provided on the first parasitic part; and a projection of the fourth slot on the frame and a projection of the third slot on the frame are at least partially non-overlapping, and the third slot, on the first frame part, is at least partially located between the feed point and the projection of the fourth slot on the first frame part.

According to the technical solution in this embodiment of this application, the third slot is at least partially located between the feed point and the projection of the fourth slot on the first frame part, so that impact of the parasitic stub on current distribution of the frame may be further reduced. With reference to the first aspect, in some implementations of the first aspect, a projection of the first slot on the frame along the first direction is located between the first ground point and the second ground point on the first frame part.

With reference to the first aspect, in some implementations of the first aspect, a projection of the feed point on the parasitic stub along the first direction is located between the second slot and the fourth slot on the first parasitic part.

According to the technical solution of this embodiment of this application, relative locations of the first slot or the second slot on the parasitic stub and the first ground point and the second ground point on the frame, as well as relative locations of the feed point on the frame and the second slot and the fourth slot on the parasitic stub are adjusted, so that impact of the parasitic stub on current distribution on the frame may be adjusted, and the maximum radiation direction of the radiation pattern generated by the antenna structure in the first band or the maximum radiation direction of the radiation pattern generated by the antenna structure in the second band may be adjusted. In this way, the maximum radiation direction of the radiation pattern generated in the first band is close to the maximum radiation direction of the radiation pattern generated in the second band.

With reference to the first aspect, in some implementations of the first aspect, an angle between the first ground point and the feed point in a ring circumference is greater than or equal to 60° and less than or equal to 108°.

According to the technical solution in this embodiment of this application, locations of the first ground point and the feed point are used, so that the ground point is usually a large current point (which increases current intensity at a ground location). Grounding at the first ground point may change locations of zero current points generated in the second band and the third band on two sides of the frame, and current distribution of the frame in the second band and the third band is adjusted. In this way, the maximum radiation direction of the radiation pattern generated in the second band is close to the maximum radiation direction of the radiation pattern generated in the third band, and the second band and the third band meet the requirement for angle alignment (where for example, the angle difference between the maximum radiation direction of the radiation pattern generated in the second band and the maximum radiation direction of the radiation pattern generated in the third band is less than or equal to) 30°. In an embodiment, based on a location relationship between the first ground point and the feed point, the antenna structure may have a good polarization characteristic (for example, right-hand circular polarization) in the first band, and a receive gain of the antenna structure for a polarized electrical signal in the first band is improved, thereby improving communication performance of the wearable device.

With reference to the first aspect, in some implementations of the first aspect, the parasitic stub further has a third slot and a fourth slot; the parasitic stub is divided into a third parasitic part and a fourth parasitic part by the third slot and the fourth slot; and a length L3 of the third parasitic part and a length L4 of the fourth parasitic part meet: (100%−10%)×L3≤L4≤(100%+10%)×L3, and an angle between the third slot and the second slot in a ring circumference is greater than or equal to 55° and less than or equal to 70°.

With reference to the first aspect, in some implementations of the first aspect, the parasitic stub further has a fifth slot and a sixth slot; the parasitic stub is divided into a fifth parasitic part and a sixth parasitic part by the fifth slot and the sixth slot; and a length L5 of the fifth parasitic part and a length L6 of the sixth parasitic part meet: (100%−10%)×L5≤L6≤(100%+10%)×L5, the fifth slot is located between the first slot and the third slot, and an angle between the fifth slot and the third slot in a ring circumference is greater than or equal to 35° and less than or equal to 45°.

According to the technical solution in this embodiment of this application, a plurality of slots are provided on the parasitic stub, so that the radiation aperture of the antenna structure may be increased, and efficiency of the antenna structure may be improved. In addition, directivity of radiation generated by the antenna structure may be adjusted by using a current generated by coupling on the parasitic stub to affect current distribution on the frame (for example, the maximum radiation direction of the radiation pattern generated in the second band or the maximum radiation direction of the radiation pattern generated in the third band). In addition, the plurality of slots are provided on the parasitic stub, so that the parasitic stub 320 may operate in a higher-order operating mode. For example, as a quantity of slots provided on the parasitic stub increases, a resonance generated by the parasitic stub shifts to a high frequency. For example, when six slots are provided on the parasitic stub, the operating mode of the parasitic stub may be a two-fold wavelength mode. When the resonance generated in this mode is close to the third band, efficiency of the third band may be increased.

With reference to the first aspect, in some implementations of the first aspect, the feed point is located between the first ground point and a projection of the first slot on the frame.

With reference to the first aspect, in some implementations of the first aspect, the feed point is configured to feed the frame, the frame is configured to generate radiation in a first band and a second band, the frame and the parasitic stub are configured to generate radiation in a third band, a frequency of the first band is lower than a frequency of the second band, and the frequency of the second band is lower than a frequency of the third band.

With reference to the first aspect, in some implementations of the first aspect, a first resonance generated by the frame and a second resonance generated by the parasitic stub are used to generate radiation in the third band.

With reference to the first aspect, in some implementations of the first aspect, a frequency of the first resonance is greater than a frequency of the second resonance.

With reference to the first aspect, in some implementations of the first aspect, a difference between the frequency of the first resonance and the frequency of the second resonance is greater than or equal to 10 MHz and less than or equal to 100 MHz.

According to the technical solution in this embodiment of this application, the frequency of the resonance (the second resonance) generated by the parasitic stub is slightly lower than the frequency of the resonance (the first resonance) generated by the frame, so that efficiency of the antenna structure in the third band may be better improved. The difference between the frequency of the first resonance and the frequency of the second resonance may be understood as a difference between a frequency of a resonance point of the first resonance and a frequency of a resonance point of the second resonance.

With reference to the first aspect, in some implementations of the first aspect, the first band includes 1176.45 MHz±10.23 MHz, and/or the second band includes 1610 MHz to 1626.5 MHz, and/or the third band includes 2483.5 MHz to 2500 MHz.

With reference to the first aspect, in some implementations of the first aspect, the wearable device further includes a filter circuit; the filter circuit is electrically connected between the frame and a ground plate at the first ground point; and the filter circuit is in a turned-off state in the first band, and is in a turned-on state in the second band and the third band.

According to the technical solution in this embodiment of this application, the filter circuit may be in a turned-on state in the first band and the second band, so that the frame is electrically connected to the ground plate; and is in a turned-off state in the third band, so that the frame is not electrically connected to the ground plate. It should be understood that, when a low-pass high-impedance filter circuit is electrically connected between a first location and the ground plate, performance (for example, directivity) of the antenna structure in the first band and the second band may be improved.

With reference to the first aspect, in some implementations of the first aspect, a seventh slot is provided on the frame, and the feed point is disposed between the seventh slot and the first ground point.

According to the technical solution in this embodiment of this application, a location of the seventh slot is adjusted, so that when an electrical signal is fed into the feed point, the seventh slot may be located in an area of the zero current point (an area in which an electric field point is strong) generated by the frame. Because the seventh slot is located in the area of the zero current point, in comparison with a case in which the seventh slot is not added, that the seventh slot is provided does not affect current distribution of the antenna structure, and therefore does not affect a radiation characteristic of the antenna structure.

With reference to the first aspect, in some implementations of the first aspect, a distance between the seventh slot and the feed point is within a range of 1 mm to 6 mm.

With reference to the first aspect, in some implementations of the first aspect, a projection of the seventh slot on the frame at least partially overlaps a projection of the first slot on the frame.

With reference to the first aspect, in some implementations of the first aspect, a second ground point is further disposed on the frame; the frame is divided into a first frame part and a second frame part by the second ground point and the feed point, and the first ground point is disposed on the first frame part; and a length D1 of the first frame part and a length D2 of the second frame part meet: (100%−10%)×D1≤D2≤(100%+10%)×D1.

With reference to the first aspect, in some implementations of the first aspect, a projection of the parasitic stub at least partially overlaps a projection of the frame in the first direction, and the first direction is a direction perpendicular to a plane on which the parasitic stub is located.

According to the technical solution in this embodiment of this application, the projection of the parasitic stub and the projection of the frame in the first direction are non-overlapping. For example, when both the parasitic stub and the frame are in a circular ring shape, a diameter of the parasitic stub may be greater than or less than that of the frame, so that the projection of the parasitic stub and the projection of the frame in the first direction are non-overlapping. This is not limited in this embodiment of this application, and may be adjusted based on a production or design requirement.

With reference to the first aspect, in some implementations of the first aspect, the wearable device further includes: an insulating bracket, where the parasitic stub is disposed on a first surface of the bracket, and at least a part of the bracket is located between the parasitic stub and the frame.

With reference to the first aspect, in some implementations of the first aspect, the wearable device is a smartwatch, and the bracket is a watch bezel.

According to the technical solution in this embodiment of this application, the bracket may be configured to ensure that there is a sufficient spacing distance between the parasitic stub and the frame in the first direction.

With reference to the first aspect, in some implementations of the first aspect, the wearable device further includes a main body and at least one wrist strap; the main body includes the frame, the bracket, and the parasitic stub; the at least one wrist strap is connected to the main body; and the projection of the first slot or a projection of the second slot on the frame corresponds to a connection joint between the at least one wrist strap and the main body.

According to the technical solution in this embodiment of this application, when a user wears the wearable device on a wrist, because the wrist is a curved surface, and a rear cover of the wearable device is a planar structure, the wearable device and the user wrist cannot completely fit, and a gap is generated between the main body and the wrist strap. The wrist strap is connected to the main body at a projection of the main body in the first slot or the second slot along the first direction, so that a distance between a strong current point and the user wrist may be increased, and an electromagnetic wave, generated by the antenna structure, that is absorbed by the user wrist is reduced, thereby improving the radiation characteristic of the antenna structure.

With reference to the first aspect, in some implementations of the first aspect, the frame is in a circular ring shape, and an inner diameter is between 35 mm and 45 mm.

According to the technical solution in this embodiment of this application, when the frame is in a rectangular ring shape or another ring shape, a circumference range of the frame may be the same as a corresponding circumference range when the frame is in the circular ring shape.

### BRIEF DESCRIPTION OF THE DRAWINGS

FIG. 1 is a diagram of a wearable device according to an embodiment of this application;

FIG. 2 is a diagram of an antenna structure according to an embodiment of this application;

FIG. 3 is a radiation pattern of the antenna structure shown in FIG. 2;

FIG. 4 is a diagram of a structure of an antenna structure 200 according to an embodiment of this application;

FIG. 5 is a side view of an antenna structure 200 according to an embodiment of this application;

FIG. 6 is a diagram of a structure of a parasitic stub 240 according to an embodiment of this application;

FIG. 7 is a diagram of a structure of another frame according to an embodiment of this application;

FIG. 8 is a diagram of a structure of another parasitic stub according to an embodiment of this application;

FIG. 9 is a partial sectional view of a wearable device according to an embodiment of this application;

FIG. 10 is a diagram of wearing a wearable device according to an embodiment of this application;

FIG. 11 is a diagram of a simulation result of an S parameter, radiation efficiency, and system efficiency of an antenna structure according to an embodiment of this application;

FIG. 12 is an S parameter of an antenna structure in which no parasitic stub is disposed according to an embodiment of this application;

FIG. 13 is a diagram of a simulation result of radiation efficiency and system efficiency of an antenna structure in which no parasitic stub is disposed according to an embodiment of this application;

FIG. 14 is a diagram of current distribution of a frame at 1.18 GHz according to an embodiment of this application;

FIG. 15 is a diagram of current distribution of a frame at 1.6 GHz according to an embodiment of this application;

FIG. 16 is a diagram of current distribution of a frame at 2.4 GHz according to an embodiment of this application;

FIG. 17 is a diagram of current distribution of a parasitic stub according to an embodiment of this application;

FIG. 18 is a diagram of magnetic field distribution of a parasitic stub according to an embodiment of this application;

FIG. 19 is a radiation pattern generated by an antenna structure at 1.6 GHz according to an embodiment of this application;

FIG. 20 is a radiation pattern generated by an antenna structure at 2.48 GHz according to an embodiment of this application;

FIG. 21 is a diagram of a structure of an antenna structure 300 according to an embodiment of this application;

FIG. 22 is a diagram of a structure of a parasitic stub 320 according to an embodiment of this application;

FIG. 23 is a diagram of a filter circuit 340 according to an embodiment of this application;

FIG. 24 is a diagram of a simulation result of an S parameter of an antenna structure according to an embodiment of this application;

FIG. 25 is a diagram of current distribution of a frame at 1.18 GHz according to an embodiment of this application;

FIG. 26 is a diagram of current distribution of a frame at 1.6 GHz according to an embodiment of this application;

FIG. 27 is a diagram of current distribution of a frame at 2.5 GHz according to an embodiment of this application;

FIG. 28 is a diagram of current distribution of a parasitic stub according to an embodiment of this application;

FIG. 29 is a simulation result of radiation efficiency according to an embodiment of this application;

FIG. 30 is a radiation pattern generated by an antenna structure at 1.6 GHz according to an embodiment of this application; and

FIG. 31 is a radiation pattern generated by an antenna structure at 2.48 GHz according to an embodiment of this application.

### DETAILED DESCRIPTION OF ILLUSTRATIVE EMBODIMENTS

Technical solutions provided in embodiments of this application are applicable to UE 103 that uses one or more of the following communication technologies: a Bluetooth (BT) communication technology, a global positioning system (GPS) communication technology, a wireless fidelity (Wi-Fi) communication technology, a global system for mobile communications (GSM) communication technology, a wideband code division multiple access (WCDMA) communication technology, a long term evolution (LTE) communication technology, a 5G communication technology, another future communication technology, and the like.

The following describes possible terms in embodiments of this application.

Coupling: may be understood as direct coupling and/or indirect coupling, and “coupling connection” may be understood as a direct coupling connection and/or an indirect coupling connection. Direct coupling may also be referred to as “electrical connection”, and may be understood as physical contact and electrical conduction of components; or may be understood as a form in which different components in a line structure are connected through a physical line that may transmit an electrical signal, for example, printed circuit board (PCB) copper foil or a conducting wire. “Indirect coupling” may be understood as electrical conduction of two conductors in an air-space or non-contact manner. In an embodiment, indirect coupling may also be referred to as capacitive coupling. For example, signal transmission is implemented by forming an equivalent capacitor through coupling in a gap between two spaced conductive members.

Connection/interconnection: may be a mechanical connection relationship or a physical connection relationship. For example, A and B are connected or A and B are interconnected may mean that there is a fastened component (for example, a screw, a bolt, a rivet) between A and B, or A and B are in contact with each other and are difficult to be separated.

Connection: Two or more components are conducted or connected in the foregoing “electrical connection” or “indirect coupling” manner to perform signal/energy transmission, which may be referred to as the connection.

Relative/relative setting: A relative setting of A and B may be an opposite-to (or face-to-face) setting of A and B.

Direct current impedance (direct current resistance, DCR): is a resistance presented by an electronic element/a mechanical part when direct current power is supplied, namely, an inherent static resistance of the element. Generally, a direct current resistance measured between any two points on an electronic element/a mechanical part is considered as a direct current resistance value of the electronic element/the mechanical part.

Resonance frequency: The resonance frequency is also referred to as a resonant frequency. The resonance frequency may be a frequency at which an imaginary part of an antenna input resistance is zero. The resonance frequency may have a frequency range, namely, a frequency range in which a resonance occurs. A frequency corresponding to a strongest resonance point is a frequency of a central frequency. A return loss characteristic of a center frequency may be less than −20 dB.

Resonance band/communication band/operating band: Regardless of a type of antenna, the antenna always operates in a specific frequency range (a band width). For example, an operating band of an antenna that supports a B40 band includes a frequency in a range of 2300 MHz to 2400 MHz, or in other words, the operating band of the antenna includes the B40 band. A frequency range that meets an indicator requirement may be considered as the operating band of the antenna.

Wavelength or operating wavelength: may be a wavelength corresponding to the center frequency of the resonance frequency or the center frequency of the operating band supported by the antenna. For example, assuming that a center frequency of a B1 uplink band (where a resonance frequency is from 1920 MHz to 1980 MHz) is 1955 MHz, the operating wavelength may be a wavelength computed based on the frequency of 1955 MHz. The “operating wavelength” is not limited to the center frequency, and may also be a wavelength corresponding to a non-center frequency of the resonance frequency or the operating band.

It should be understood that a wavelength of a radiation signal in the air may be computed as follows: (air wavelength, or vacuum wavelength)=speed of light/frequency, where a frequency is a frequency of the radiation signal (MHz), and the speed of light may be 3×108 m/s. A wavelength of the radiation signal in dielectric may be computed as follows: dielectric wavelength=(speed of light/\sqrt{ε})/frequency, where ε is a relative dielectric constant of the dielectric. The wavelength in embodiments of this application is usually the dielectric wavelength, may be the dielectric wavelength corresponding to the center frequency of the resonance frequency, or the dielectric wavelength corresponding to the center frequency of the operating band supported by the antenna. For example, assuming that the center frequency of the B1 uplink band (where the resonance frequency is from 1920 MHz to 1980 MHz) is 1955 MHz, the operating wavelength may be a dielectric wavelength computed based on the frequency of 1955 MHz. The “dielectric wavelength” is not limited to the center frequency, and may also be a dielectric wavelength corresponding to a non-center frequency of the resonance frequency or the operating band. For ease of understanding, the dielectric wavelength mentioned in embodiments of this application may be simply computed by using a relative dielectric constant of dielectric filled on one or more sides of a radiator.

Limitations such as parallel, vertical, and same (for example, a same length and a same width) mentioned in embodiments of this application are all for a current process level, but are not absolutely strict definitions in a mathematical sense. For example, there may be an offset of a preset angle (for example, ±5°, or ±10°) between two antenna elements that are parallel or perpendicular to each other.

Antenna system efficiency (total efficiency): is a ratio of input power to output power at an antenna port.

Antenna radiation efficiency: is a ratio of power radiated by the antenna to space (namely, power that is effectively converted into an electromagnetic wave part) to active power input to the antenna. Active power input to the antenna=input power of the antenna−loss power. The loss power mainly includes return loss power and ohmic loss power and/or dielectric loss power of metal. Radiation efficiency is a value used to measure a radiation capability of the antenna. A metal loss and a dielectric loss are factors that affect the radiation efficiency.

A person skilled in the art may understand that efficiency is generally represented by a percentage, and there is a corresponding conversion relationship between the efficiency and dB. The closer the efficiency is to 0 dB, the better the antenna efficiency is.

Antenna radiation pattern: is also referred to as a radiation pattern. The antenna radiation pattern is a pattern in which relative field strength (a normalized modulus value) of an antenna radiation field changes with a direction at a specific distance from an antenna. The antenna radiation pattern is usually represented by two plane radiation patterns that are perpendicular to each other in a maximum radiation direction of the antenna.

The antenna radiation pattern usually includes a plurality of radiation beams. A radiation beam with highest radiation strength is referred to as a main lobe, and another radiation beam is referred to as a minor lobe or side lobe. In minor lobes, a minor lobe in an opposite direction of the main lobe is also referred to as a back lobe.

Antenna return loss: may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one type of an S parameter. S11 indicates a reflection coefficient. This parameter indicates transmit efficiency of the antenna. The S11 parameter is usually a negative number. A smaller S11parameter indicates a smaller return loss of the antenna and smaller energy reflected back by the antenna, that is, indicates more energy actually entering the antenna and higher system efficiency of the antenna. A larger S11 parameter indicates a larger return loss of the antenna and lower system efficiency of the antenna.

It should be noted that, in engineering, a value of S11 is generally −6 dB as a standard. When the value of S11 of the antenna is less than −6 dB, it may be considered that the antenna may operate normally, or it may be considered that the transmit efficiency of the antenna is good.

Ground (ground plate): may be generally referred to as at least a part of any grounding layer, grounding plate, grounding metal layer, or the like in an electronic device (for example, a mobile phone), or at least a part of any combination of any grounding layer, grounding plate, grounding component, or the like. “Ground” may be used to ground a component in the electronic device. In an embodiment, “ground” may be a grounding layer of a circuit board of the electronic device, or may be a grounding metal layer formed by a grounding plate formed using a middle frame or a metal thin film below a screen in the electronic device. In an embodiment, the circuit board may be a printed circuit board (PCB), for example, an 8-layer, 10-layer, 12-layer, 13-layer, or 14-layer board having 8, 10, 12, 13, or 14 layers of conductive material, or an element that is separated and electrically insulated by a dielectric layer or insulation layer such as glass fiber, polymer, or the like. In an embodiment, the circuit board includes a dielectric substrate, a grounding layer, and a wiring layer, and the wiring layer and the grounding layer may be electrically connected through a via. In an embodiment, components such as a display, a touchscreen, an input button, a transmitter, a processor, a memory, a battery, a charging circuit, and a system on chip (SoC) structure may be installed on or connected to a circuit board, or electrically connected to a wiring layer and/or a grounding layer in the circuit board. For example, a radio frequency source is disposed at the wiring layer.

Any of the foregoing grounding layers, or grounding plates, or grounding metal layers is made of a conductive material. In an embodiment, the conductive material may be any one of the following materials: copper, aluminum, stainless steel, brass and alloys thereof, copper foil on insulation laminates, aluminum foil on insulation laminates, gold foil on insulation laminates, silver-plated copper, silver-plated copper foil on insulation laminates, silver foil on insulation laminates and tin-plated copper, cloth impregnated with graphite powder, graphite-coated laminates, copper-plated laminates, brass-plated laminates and aluminum-plated laminates. A person skilled in the art may understand that the grounding layer/grounding plane/grounding metal layer may alternatively be made of other conductive materials.

The following describes technical solutions of embodiments in this application with reference to accompanying drawings.

A wearable device provided in this application may be a portable device, or may be a device that can be integrated into clothes or accessories of a user. The wearable device has a computing function, and may be connected to a mobile phone and various terminal devices. For example, the wearable device may be a watch, a smart wrist strap, a portable music player, a health monitoring device, a computing or game device, a smartphone, an accessory, or the like. In some embodiments, the wearable device is a smartwatch that can be worn around a user wrist.

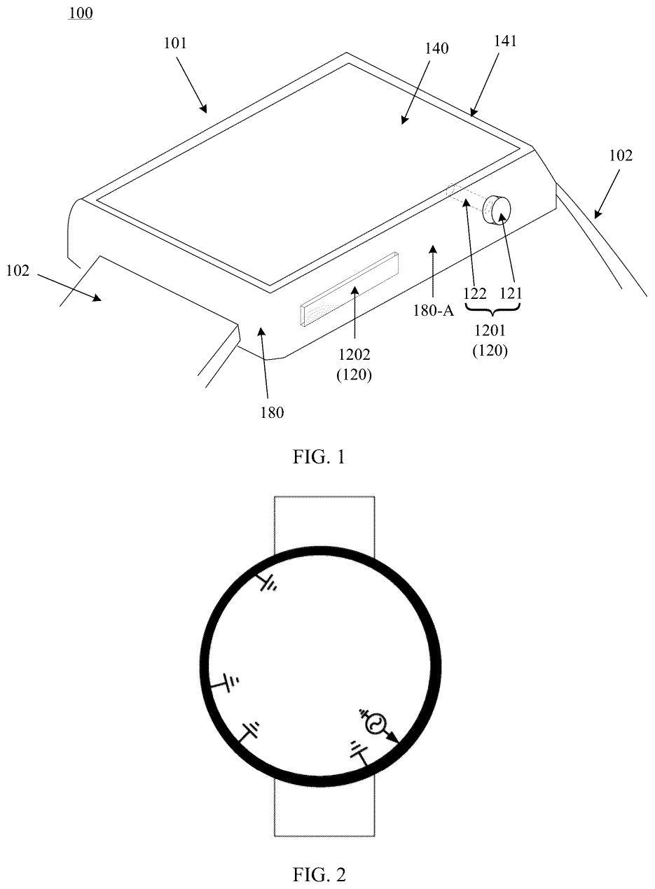

FIG. 1 is a diagram of a structure of a wearable device according to this application. In some embodiments, the wearable device may be a watch or a wristband.

Refer to FIG. 1. The wearable device 100 includes a main body 101 and one or more wrist straps 102 (where FIG. 1 shows a part of an area of the wrist strap 102). The wrist strap 102 is fixedly connected to the main body 101, and the wrist strap 102 may be wound around a wrist, an arm, a leg, or another part of a body, to fasten the wearable device to a user. As a central element of the wearable device 100, the main body 101 may include a metal frame 180 and a screen 140. The metal frame 180 may encircle the wearable device, is a part of an appearance of the wearable device, and encircles the screen 140 and a watch bezel 141. An edge of the watch bezel 141 is adjacent to and fastened on the metal frame 180, the screen 140 may be disposed in space encircled by the watch bezel 141, and the screen 140 and the watch bezel 141 form a surface of the main body 101. Accommodation space is formed between the metal frame 180 and the screen 140, and a combination of a plurality of electronic elements may be accommodated, to implement various functions of the wearable device 100. The main body 101 further includes an input device 120, a part of the input device 120 may be accommodated in the accommodation space between the metal frame 180 and the screen 140, and an exposed part of the input device 120 is convenient for the user to contact.

It may be understood that, in this embodiment of this application, the metal frame 180 of the wearable device may be a circle, a square, or a polygon, or may be in various other regular or irregular shapes. This is not limited herein. For brevity of description, the following embodiments are described by using the circular metal frame 180 as an example.

The screen 140 and the watch bezel 141 are used as surfaces of the main body 101, and may be used as protection plates of the main body 101, to avoid damage caused by exposed parts accommodated in the metal frame 180. For example, the watch bezel 141 may be made of a ceramic material, which improves aesthetics when providing good protection for the main body 101. For example, the screen 140 may include a liquid crystal display (LCD) and a protective part covering a surface of the display. The protective part may be sapphire crystal, glass, plastic, or another material.

The user may interact with the wearable device 100 through the screen 140. For example, the screen 140 may receive an input operation of the user, and perform a corresponding output in response to the input operation. For example, the user may choose (or in another manner) to open or edit a graphic and the like by touching or pressing a graphic location on the screen 140.

The input device 120 is attached to an outer side of the metal frame 180 and extends to the inside of the metal frame 180. In some embodiments, the input device includes a head 121 and a rod part 122 that are connected. The rod part 122 extends into a housing 180, and the head 121 is exposed outside the housing 180 and may be used as a part in contact with the user, to allow the user to contact the input device. The screen 140 receives the input operation of the user by rotating, translating, tilting, or pressing the head 121. When the user operates the head 121, the rod part 122 may move with the head 121. It may be understood that the head 121 may be in any shape. For example, the head 121 may be in a cylindrical shape. It may be understood that the rotatable input device 120 may be referred to as a button. In an embodiment in which the wearable device 100 is a watch, the rotatable input device 120 may be a crown of the watch. The input device 120 may be referred to as a watch crown.

The wearable device 100 includes a key 1202. As an example of the input device 120, the wearable device 100 may allow the user to press, move, or tilt the key 1202 to perform the input operation. For example, the key 1202 may be installed on a side surface 180-A of the metal frame 180, a part of the key 1202 is exposed, and the other part extends from the side surface of the metal frame 180 toward the inside of the housing 180 (not shown in the figure). For example, the key 1202 may alternatively be disposed on the head 121 of the button 1201, and a pressing operation may also be performed when a rotation operation is performed. For example, the key 1202 may alternatively be disposed on a top surface, of the main body 101, on which the display screen 140 is installed.

Still refer to FIG. 1. In some other embodiments, the wearable device 100 may include the button 1201 and the key 1202. The button 1201 and the key 1202 may be disposed on a same surface of the metal frame 180. For example, both the button 1201 and the key 1202 are disposed on a same side surface of the metal frame 180. The button 1201 and the key 1202 may alternatively be disposed on different surfaces of the metal frame 180. This is not limited in this application. It may be understood that the wearable device 100 may include one or more keys 1202, or may include one or more buttons 1201.

FIG. 2 is a diagram of an antenna structure according to an embodiment of this application.

As shown in FIG. 2, a metal frame of a wearable device is used as a radiator of the antenna structure. A ground point and a feed point are disposed at different locations of the frame, so that the antenna structure may generate radiation. However, because another electronic element further needs to be disposed inside the metal frame, the locations of the ground point and the feed point need to be adjusted based on a layout of the electronic element disposed inside the metal frame. For the antenna structure, there is no sufficient space for design, and it is difficult to ensure radiation performance (for example, bandwidth, a gain, and efficiency) of the antenna structure.

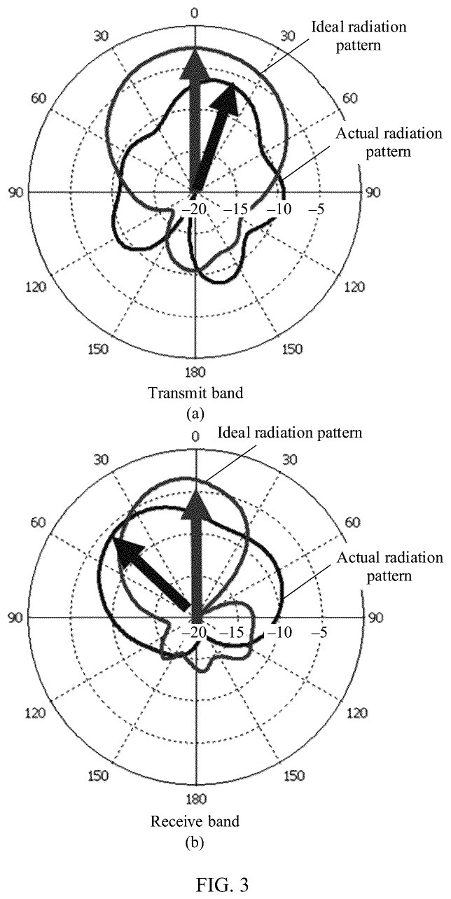

In addition, generally, the antenna structure of the wearable device mostly focuses on an antenna efficiency indicator, and does not focus on a radiation pattern of generated radiation in a far field. Therefore, in a band in which a BeiDou satellite system communication technology is added, because a frequency difference between a transmit band (1610 MHz to 1626.5 MHz) and a receive band (2483.5 MHz to 2500 MHz) of the BeiDou satellite system communication technology is large, current distribution when a resonance is generated in a corresponding band is different. Therefore, a maximum radiation direction of a radiation pattern generated in the transmit band differs greatly from a maximum radiation direction of a radiation pattern generated in the receive band, as shown in FIG. 3. As shown in (a) in FIG. 3, in the transmit band, the maximum radiation direction of the generated radiation pattern points to a direction of about 20° to the right of 0°. As shown in (b) in FIG. 3, in the receive band, the maximum radiation direction of the generated radiation pattern points to a direction of about 45° to the left of 0°. A difference between the maximum radiation direction of the radiation pattern generated in the transmit band and the maximum radiation direction of the radiation pattern generated in the receive band is approximately 55°. Consequently, the transmit band and the receive band cannot meet a requirement for angle alignment, and accuracy of transmitting a BeiDou communication short message by the antenna structure is reduced.

“The maximum radiation direction of the radiation pattern” may be understood as a direction to which a maximum value of a gain in the radiation pattern points.

In addition, in the antenna structure shown in FIG. 2, a gain requirement of the antenna structure applied to the BeiDou satellite system communication technology cannot be met.

Therefore, this embodiment of this application provides a wearable device. A conductive frame of the wearable device is used as the radiator of the antenna structure, and relative locations of the ground point and the feed point are used, so that maximum radiation directions of radiation patterns generated in different bands are consistent, to meet a requirement for angle alignment in different bands.

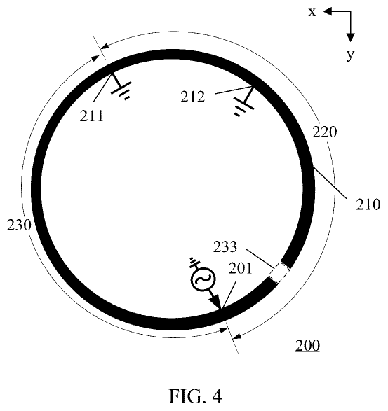

FIG. 4 is a diagram of a structure of an antenna structure 200 according to an embodiment of this application. The antenna structure 200 may be applied to the wearable device 100 shown in FIG. 1.

As shown in FIG. 4, the antenna structure 200 may include a conductive frame 210, and the frame 210 may be the metal frame 180 in FIG. 1. The frame 210 may be in a ring shape, for example, in a circular ring shape, a rectangular ring shape, or another ring shape.

In an embodiment, a first ground point 211 and a feed point 201 are disposed on the frame 210. The frame 210 is grounded at the first ground point 211, and is electrically connected to a ground plate. The feed point 201 is configured to feed an electrical signal into the antenna structure 200.

In an embodiment, a first ground point 211, a second ground point 212, and feed point 201 are disposed on the frame 210. The frame 210 is grounded at the first ground point 211 and the second ground point 212, and is electrically connected to a ground plate. The feed point 201 is configured to feed an electrical signal into the antenna structure 200. The frame 210 is divided into a first frame part 220 and a second frame part 230 by the first ground point 211 and the feed point 201, and the second ground point 212 is disposed on a frame 210 of the first frame part 220. A length L1 of the frame 210 of the first frame part 220 is the same as a length L2 of a frame 210 of the second frame part 230. During actual engineering application, based on a layout inside the wearable device, the length L1 of the frame 210 of the first frame part 220 and the length L2 of the frame 210 of the second frame part 230 may have an offset. Therefore, when the length L1 of the frame 210 of the first frame part 220 and the length L2 of the frame 210 of the second frame part 230 meet: (100%−10%)×L1≤L2≤(100%+10%)×L1, it may be considered that (100%−10%)×L1≤L2≤(100%+10%)×L1 is the same.

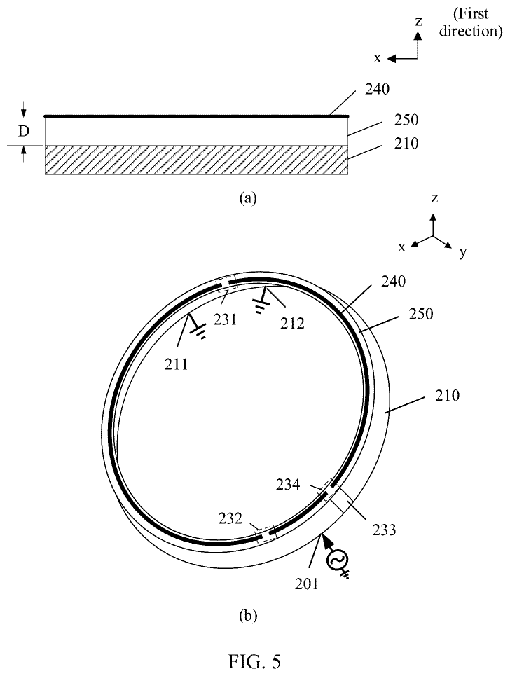

As shown in FIG. 5, the antenna structure may further include a parasitic stub 240. The parasitic stub 240 may be in a ring shape, for example, in a circular ring shape, a rectangular ring shape, or another ring shape. In an embodiment, both the frame 210 and the parasitic stub 240 are in a circular ring shape. In an embodiment, both the frame 210 and the parasitic stub 240 are in a rectangular ring shape. In an embodiment, both the frame 210 and the parasitic stub 240 are in a square ring shape.

In an embodiment, the parasitic stub 240 and the frame 210 are spaced in ring circumferences. In an embodiment, the parasitic stub 240 and the frame 210 are not in contact with each other in respective ring circumferences.

In an embodiment, the parasitic stub 240 and the frame 210 may be concentric rings that do not contact with each other. The concentric ring may be understood as that a central axis of a ring shape formed by the frame 210 is the same as a central axis of a ring shape formed by the parasitic stub 240 (where a distance between the two central axes in a plane on which the frame 210 or the parasitic stub 240 is located is less than or equal to 5%), and the central axis of the ring shape formed by the frame 210 may be understood as a geometric center that passes through the frame 210 and is perpendicular to a virtual axis of the plane on which the frame 210 is located. The central axis of the ring shape formed by the parasitic stub 240 may also be understood correspondingly.

In an embodiment, the parasitic stub 240 is located above the frame 210 in a first direction (where when being worn, the parasitic stub 240 is on a side away from a user), and is separated from the frame 210 in the first direction along the ring circumference (where the frame 210 and the parasitic stub 240 are disposed in a stacking manner in a thickness direction of the wearable device). In an embodiment, the first direction is a direction perpendicular to the plane on which the parasitic stub 240 is located. In an embodiment, the first direction may be understood as the thickness direction of the wearable device. For example, the first direction may be a z direction shown in FIG. 5. In an embodiment, the plane on which the parasitic stub 240 is located is approximately parallel to the plane on which the frame 210 is located.

In an embodiment, projections of the parasitic stub 240 and the frame 210 in the first direction may partially overlap or may non-overlap. For example, when both the parasitic stub 240 and the frame 210 are in a circular ring shape, a diameter of the parasitic stub 240 may be greater than or less than that of the frame 210, so that the projections of the parasitic stub 240 and the frame 210 in the first direction are non-overlapping. For brevity of description, this embodiment of this application is described only by using an example in which the projections of the parasitic stub 240 and the frame 210 in the first direction completely overlap, as shown in (a) and (b) in FIG. 5. This is not limited in this embodiment of this application, and may be adjusted based on a production or design requirement.

It should be understood that the “plane on which the parasitic stub 240 is located” may be understood as a plane corresponding to the circumference of the parasitic stub 240, or a surface of the parasitic stub 240 in the circumference is not a plane (for example, a trapezoid shape spliced by a plurality of planes), and the “plane on which the parasitic stub 240 is located” may also be understood as a plane on which the wearable device contacts with the user when the user wears the parasitic stub 240.

As shown in FIG. 6, a first slot 231 and a second slot 232 are provided on the parasitic stub 240.

It should be understood that, in the technical solution provided in this embodiment of this application, the parasitic stub 240 that is spaced from a radiator (the frame 210) and that is not in contact with the radiator is disposed in the antenna structure, and the parasitic stub 240 may generate an additional resonance by using energy coupled to the parasitic stub 240 when the radiator is resonant, so that performance (for example, bandwidth, a gain, and efficiency) of the antenna structure may be extended. In an embodiment, when a band corresponding to the resonance generated by the parasitic stub is the same as a part of an operating band generated by the radiator, efficiency of the part of the operating band may be improved. For example, the resonance generated by the parasitic stub 240 may include a first band or a second band. In an embodiment, when the resonance generated by the parasitic stub is slightly lower than or slightly higher than a resonance generated by the radiator, efficiency of the radiator in this operating band may be improved. For example, a difference between the resonance generated by the parasitic stub 240 and the resonance generated by the radiator may be greater than or equal to 10 MHz and less than or equal to 100 MHz. In addition, the first slot 231 and the second slot 232 are provided on the parasitic stub 240, so that a radiation aperture of the antenna structure may be increased, and efficiency of the antenna structure may be improved. In addition, directivity of radiation generated by the antenna structure may be adjusted by using a current generated by coupling on the parasitic stub 240 to affect current distribution on the frame 210 (for example, a maximum radiation direction of a radiation pattern generated in the first band or a maximum radiation direction of a radiation pattern generated in the second band).

It should be understood that, in the technical solution in this embodiment of this application, current distribution of the antenna structure 200 in the first band and the second band may be adjusted by locations of the first ground point 211 and the feed point 201. A frequency of the first band is lower than a frequency of the second band. In an embodiment, the first ground point 211 may be disposed between a zero current point generated by the frame 210 in the first band and a zero current point generated by the frame 210 in the second band. Because the ground point is usually a large current point (which increases current intensity at a grounding location), locations of the two zero current points may be changed between the two zero current points generated in the first band and the second band. In this way, the maximum radiation direction of the radiation pattern generated by the antenna structure 200 in the first band is close to the maximum radiation direction of the radiation pattern generated by the antenna structure 200 in the second band. In addition, the second ground point 212 may further make the maximum radiation direction of the radiation pattern generated by the antenna structure 200 in the first band close to the maximum radiation direction of the radiation pattern generated by the antenna structure 200 in the second band. Therefore, the first band and the second band meet a requirement for angle alignment (where for example, an angle difference between the maximum radiation direction of the radiation pattern generated in the first band and the maximum radiation direction of the radiation pattern generated in the second band is less than or equal to) 30°.

In an embodiment, the first band includes a transmit band of a BeiDou satellite system communication band, for example, 1610 MHz to 1626.5 MHz (an L band), and the second band includes a receive band of the BeiDou satellite system communication band, for example, 2483.5 MHz to 2500 MHz (an S band). Alternatively, in an embodiment, the first band may include a part of bands in a low band (LB) (698 MHz to 960 MHz), a middle band (MB) (1710 MHz to 2170 MHz), and a high band (HB) (2300 MHz to 2690 MHz) in a 4G communication system, and the second band may include a part of bands that are in the LB (698 MHz to 960 MHz), the MB (1710 MHz to 2170 MHz), and the HB (2300 MHz to 2690MHz) in the 4G communication system and that do not overlap those of the first band. It should be understood that an operating band (an umbrella term for a transmit band and a receive band) of a BeiDou satellite system communication technology may further include a B1 (1559 Hz to 1591 MHz) band, a B2 (1166 MHz to 1217 MHz) band, and a B3 (1250 MHz to 1286 MHz) band. For brevity, only the L band (or the transmit band) and the S band (or the receive band) are used as an example for description in this embodiment of this application.

In an embodiment, the operating band of the antenna structure 200 may include a part of bands in a cellular network. In an embodiment, the feed point 201 may be further configured to feed an electrical signal in at least one band of B5 (824 MHz to 849 MHz), B8(890 MHz to 915 MHz), and B28 (704 MHz to 747 MHz).

In an embodiment, the operating band of the antenna structure 200 may further include a third band, and a frequency of the third band is lower than the frequency of the first band. In an embodiment, the third band may include an L5 band (1176.45 MHz±10.23 MHz) in a GPS. In an embodiment, a resonance band generated by a one-fold wavelength mode of the frame 210 may include the third band, a resonance band generated by a two-thirds wavelength mode of the frame 210 may include the first band, and a resonance band generated by a two-fold wavelength mode of the frame 210 may include the second band.

It should be understood that, in the foregoing operating band, the operating band of the antenna structure 200 may further include the first band. It may be understood as that the antenna structure may operate at any frequency in the first band, for example, transmit or receive an electrical signal at any frequency in the first band. This may also be correspondingly understood in the following embodiments.

When the feed point 201 feeds the electrical signal, the frame 210 and the parasitic stub 240 may be configured to generate radiation in the first band. In an embodiment, that the parasitic stub 240 generates radiation in the first band may be understood as that the parasitic stub 240 may be used to improve efficiency of the antenna structure in the first band. In an embodiment, that the parasitic stub 240 generates radiation in the first band may be understood as that at least a part of a resonance generated by the parasitic stub 204 falls into the first band. For example, a part of an S11 curve of the resonance generated by the parasitic stub 204 below a first threshold (for example, −4 dB) at least partially overlaps the first band. It should be understood that a center frequency of the resonance generated by the parasitic stub 204 may be inside the first band or outside the first band. Provided that existence of the parasitic stub 240 improves radiation efficiency of the antenna structure in the first band, it may be considered that the frame 210 and the parasitic stub 240 are configured to generate radiation in the first band. In an embodiment, the first band may include the transmit band (1610 MHz to 1626.5 MHz) in the BeiDou satellite system communication technology, to improve efficiency of the antenna structure in the transmit band, and improve accuracy of transmitting a BeiDou short message.

In an embodiment, a size of the parasitic stub 240 may be approximately the same as a size of the frame 210. For example, the ring circumference of the parasitic stub 240 is within (1±10%) of the ring circumference of the frame 210. In an embodiment, an outer diameter R3 of the parasitic stub 240 may be less than an outer diameter R1 of the frame 210 and greater than an inner diameter R2 of the frame 210.

In an embodiment, a length L3 of a third frame part between the first ground point 211 and the second ground point 212 and the total length Li of the frame 210 of the first frame part 220 meet: (33%−10%)×L1≤L3≤(33%+10%)×L1, and the first frame part 220 includes the third frame part.

It should be understood that, when the second ground point 212 is disposed at a location about ⅓ L1 away from the first ground point 211, the second ground point 212 an area in which a large current point generated by the frame 210 in the first band is located, and a ground point is disposed in the area in which the large current point is located, so that a location of the large current point is not changed. However, because the second ground point 212 is disposed at the location, a location of a zero current point generated by the frame 210 in the second band is changed, so that the maximum radiation direction of the radiation pattern generated by the antenna structure 200 in the second band is close to the maximum radiation direction of the radiation pattern generated by the antenna structure 200 in the first band.

In an embodiment, a third slot 233 is provided on the frame 210. The third slot 233 is located between the second ground point 212 and the feed point 201 on the first frame part 220. For example, the third slot 233 is disposed at a first terminal of the first frame part 220, and the first terminal is a terminal that is of the first frame part 220 and that is close to the feed point 201. In an embodiment, the first terminal may be understood as a part of the frame that includes an endpoint and whose distance from the endpoint is less than the first threshold. For example, the first threshold may be one-sixteenth of a first wavelength, and the first wavelength may be a wavelength corresponding to a resonance frequency of the antenna structure 200, or may be a wavelength corresponding to a center frequency of the antenna structure 200. Alternatively, the first threshold may be 6 mm.

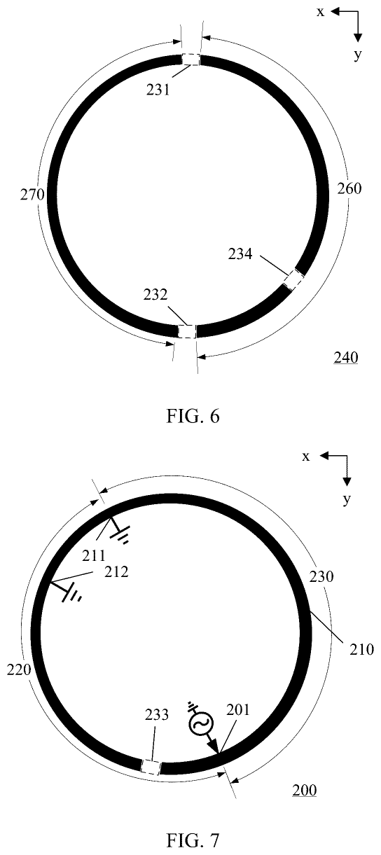

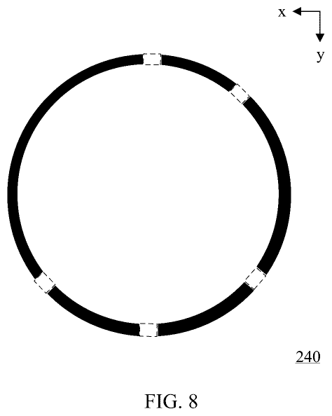

In the foregoing embodiment, an example in which the first frame part 220 is disposed on a right side (a right side of a connection line between the first ground point 211 and the feed point 201) is used for description. During actual engineering or application, the first frame part 220 may alternatively be disposed on a left side, as shown in FIG. 7. For example, the second ground point 212 or the third slot 233 is disposed on a left side (a left side of the connection line between the first ground point 211 and the feed point 201), and same technical effect may also be achieved.

In an embodiment, on the first frame part 220, a distance between the third slot 233 and the feed point 201 may be within a range of 1 mm to 6 mm. In an embodiment, a distance between the third slot 233 and the feed point 201 may be within a range of 2 mm to 5 mm. The distance between the third slot 233 and the feed point 201 may be understood as a distance between the third slot 233 and the feed point 201 along the frame 210.

It should be understood that, a location of the third slot 233 is adjusted, so that when the feed point 201 feeds the electrical signal, the third slot 233 may be located in areas of the zero current points generated by the frame 210 in the first band and the second band. The slot location is usually the zero current point (which reduces current intensity at the slot location). Because the third slot 233 is located in the area of the zero current point, in comparison with a case in which the third slot 233 is not added, that the third slot 233 is provided does not affect current distribution of the antenna structure 200, and therefore does not affect a radiation characteristic of the antenna structure 200. In addition, because the third slot 233 is disposed on the frame 210, a radiation environment of the antenna structure 200 is improved, so that a part of an electromagnetic field bound between the frame 210 and the ground plate may be radiated outward through the third slot 233. In addition, when the operating frequency of the antenna structure 200 is lower than the first band, the slot may also be equivalent to a capacitor, which is equivalent to increasing a length of the radiator of the antenna structure and increasing the radiation aperture of the antenna structure 200.

In an embodiment, a distance d between the parasitic stub 240 and the frame 210 is greater than or equal to 0.3 mm. In an embodiment, a distance d between the parasitic stub 240 and the frame 210 is greater than or equal to 0.8 mm. In an embodiment, a distance d between the parasitic stub 240 and the frame 210 is less than or equal to 4 mm. In an embodiment, a distance d between the parasitic stub 240 and the frame 210 is less than or equal to 3 mm. The distance d between the parasitic stub 240 and the frame 210 may be understood as a shortest straight-line distance between the parasitic stub 240 and the frame 210. In an embodiment, the parasitic stub 240 and the frame 210 are concentric rings that do not contact each other, and the distance between the parasitic stub 240 and the frame 210 may be a distance from any point on the parasitic stub 240 to a corresponding point on the frame 210 in a circumferential direction.

In an embodiment, a distance D between the parasitic stub 240 and the frame 210 in the first direction is greater than or equal to 0.3 mm. Alternatively, in an embodiment, a distance D between the parasitic stub 240 and the frame 210 in the first direction is greater than or equal to 0.8 mm.

In an embodiment, a distance D between the parasitic stub 240 and the frame 210 in the first direction is less than or equal to 4 mm. Alternatively, in an embodiment, a distance D between the parasitic stub 240 and the frame 210 in the first direction is less than or equal to 3 mm.

In an embodiment, a width w of the parasitic stub 240 may be greater than 1 mm. Alternatively, in an embodiment, a width w of the parasitic stub 240 may be greater than 2.5 mm. In an embodiment, a width w of the parasitic stub 240 may be less than 3 mm. It should be understood that the parasitic stub 240 may be implemented through a manner such as a flexible printed circuit (FPC), laser-direct-structuring (LDS), coating, metal plating, or the like. A thickness of the parasitic stub 240 may be determined based on different implementations. Correspondingly, in an embodiment, a direct current resistance of the parasitic stub 240 may be less than or equal to 0.5Ω, so that a loss of the parasitic stub 240 is small. In an embodiment, a direct current resistance value measured at any two points (two points that are not separated by a slot) on the parasitic stub 240 may be considered as a direct current resistance of the parasitic stub 240.

The distance d between the parasitic stub 240 and the frame 210, the distance D between the parasitic stub 240 and the frame 210 in the first direction, and the width w of the parasitic stub 240 may adjust a magnitude of an electrical signal coupled by the parasitic stub 240 from the frame 210. When d, D, and/or w are different values, a resonance point generated by the parasitic stub 240 correspondingly moves, so that a resonance band generated by the parasitic stub 240 may include different bands.

In some embodiments, the distance D between the parasitic stub 240 and the frame 210 in the first direction may be, for example, within a range of 0.5 mm to 1.5 mm, or may be, for example, within a range of 0.6 mm to 1.2 mm. It should be understood that a distance range is limited by a product process on the one hand and a product appearance on the other hand. The foregoing distance range is provided as an example in this embodiment of this application, and is not intended to limit the scope of this application. When the product process and/or the product appearance are/is no longer limited (where for example, in the product process, a thinner parasitic stub bracket may be implemented, and/or in term of the product appearance, a thicker product thickness may be accepted), the distance between the parasitic stub 240 and the frame 210 in the first direction may not be within a range of 0.3 mm to 4 mm.

In an embodiment, the parasitic stub 240 is divided into a first parasitic part 260 and a second parasitic part 270 by the first slot 231 and the second slot 232. A length L4 of a parasitic stub 240 of the first parasitic part 260 and a length L5 of a parasitic stub 240 of the second parasitic part 270 meet: (100%−10%)×L4≤L5≤(100%+10%)×L4.

In an embodiment, the feed point 201 is located between a projection of the second slot 232 on the frame 210 and the third slot 233. It should be understood that when the feed point 201 feeds the electrical signal, the parasitic stub 240 generates the resonance through coupling, and the first slot 231 and the second slot 232 may be located in a corresponding area, of a strong current point, in which the first slot 231 and the second slot 232 are not disposed on the parasitic stub 240, so that the strong current point shifts, thereby adjusting current distribution when the parasitic stub 240 generates the resonance.

It should be understood that the projection of the second slot 232 on the frame 210 may be understood as a part that falls on the frame 210 in a process of projecting the second slot 232 to a horizontal plane in a direction (for example, a z direction) perpendicular to the horizontal plane when the wearable device is placed on the horizontal plane in a forward direction (a distance between the frame 210 and the horizontal plane (the ground) is less than a distance between the parasitic stub 240 and the horizontal plane). Alternatively, the projection of the second slot 232 on the frame 210 may be understood as a projection of the second slot 232 on a first plane of the frame 210 when the wearable device is placed on the horizontal plane in a forward direction. The first plane may be a plane on which points that are on the frame 210 and that have a same distance from the horizontal plane are located. In the following embodiments, a projection on the frame may be understood correspondingly.

The foregoing understanding may be a case in which the parasitic stub 240 at least partially overlaps the frame 210 in a direction perpendicular to the horizontal plane.

In an embodiment, the parasitic stub 240 and the frame 210 are non-overlapping in the direction perpendicular to the horizontal plane. For example, in the direction perpendicular to the horizontal plane, the parasitic stub 240 and the frame 210 are basically concentric rings, and an entire ring in which the parasitic stub 240 is located is located inside a ring in which the frame 210 is located. For example, an outer circumference of the parasitic stub 240 is located within an inner circumference of the frame 210. In this case, the projection of the second slot 232 on the frame 210 may be understood as a part that is on the frame 210 and that is closest to the projection of the second slot 232 on the horizontal plane when the wearable device is placed on the horizontal plane in the forward direction and the second slot 232 is projected to the horizontal plane in the direction (for example, the z direction) perpendicular to the horizontal plane. For example, when the second slot 232 is located on the ring of the parasitic stub 240 in a 12-hour direction, the projection of the second slot 232 on the frame 210 is a corresponding location on the ring of the frame 210 in the 12-hour direction.

A projection of a corresponding location of the parasitic stub 240 on the frame 210, or a projection of a corresponding location of the frame 210 on the parasitic stub 240 should be understood in a same or similar manner with reference to the foregoing descriptions.

In an embodiment, a fourth slot 234 may be further provided on the parasitic stub 240. The fourth slot 234 is, for example, provided on the first parasitic part 260.

It should be understood that, when the parasitic stub 240 generates the resonance, the fourth slot 234 is provided on the parasitic stub 240, so that impact of a current generated on the parasitic stub 240 on current distribution on the frame 210 may be reduced, and impact on the maximum radiation direction of the radiation pattern generated by the antenna structure may be reduced. A projection location relationship between the fourth slot 234 and the third slot 233 in the first direction may be for adjusting the impact of the current generated on the parasitic stub 240 on the current distribution on the frame 210.

In an embodiment, the fourth slot 234 at least partially overlaps the third slot 233 in the circumferential direction. For example, a distance between the fourth slot 234 and the third slot 233 is the same as the distance between the parasitic stub 240 and the frame 210, and the distance between the fourth slot 234 and the third slot 233 may be understood as a shortest straight-line distance between the fourth slot 234 and the third slot 233.

Alternatively, in an embodiment, the fourth slot 234 and the third slot 233 are at least partially non-overlapping in the circumferential direction. For example, the third slot 233, on the first frame part 220 is at least partially located between the feed point 201 and a projection of the fourth slot 234 on the first frame part 220. The distance between the fourth slot 234 and the third slot 233 is greater than the distance between the parasitic stub 240 and the frame 210. The distance between the fourth slot 234 and the third slot 233 may be understood as the shortest straight-line distance between the fourth slot 234 and the third slot 233.

In an embodiment, the fourth slot 234 at least partially overlaps the third slot 233 in the first direction.

Alternatively, in an embodiment, the fourth slot 234 and the third slot 233 are at least partially non-overlapping in the first direction. The third slot 233, on the first frame part 220, is at least partially located between the feed point 201 and the projection of the fourth slot 234 on the first frame part 220. The impact of the parasitic stub 240 on the current distribution of the frame 210 can be further reduced.

When the fourth slot 234 on the parasitic stub 240 at least partially overlaps the third slot 233 in the circumferential direction or the first direction, a coupling amount between the parasitic stub 240 and the frame 210 is a CP1; and when the fourth slot 234 on the parasitic stub 240 and the third slot 233 are at least partially non-overlapping in the circumferential direction or the first direction, a coupling amount between the parasitic stub 240 and the frame 210 is a CP2, where the CP1>the CP2.

A person skilled in the art should understand that the coupling amount between the parasitic stub 240 and the frame 210 is related to the following several aspects:
(a) the distance between the parasitic stub 240 and the frame 210 in the circumferential direction or the first direction;
(b) the projection location relationship between the fourth slot 234 and the third slot 233 in the circumferential direction or the first direction;
(c) a slot width of the fourth slot 234 and/or the third slot 233; and/or
(d) a quantity of slots on the parasitic stub 240 and/or the frame 210.

When the distance between the parasitic stub 240 and the frame 210 in the circumferential direction or the first direction is large (for example, ≥1 mm), the coupling amount between the parasitic stub 240 and the frame 210 may be small. In some embodiments, the projection of the fourth slot 234 at least partially overlaps the projection of the third slot 233 in the circumferential direction or the first direction (where for example, the projection are aligned), or the projection of the third slot 233 in the circumferential direction or the first direction falls into the fourth slot 234, which may compensate for an insufficient coupling amount due to a large distance.

When the distance between the parasitic stub 240 and the frame 210 in the circumferential direction or the first direction is small (for example, <1 mm), the coupling amount between the parasitic stub 240 and the frame 210 may be small. In some embodiments, the projection of the fourth slot 234 and the projection of the third slot 233 are at least partially non-overlapping in the circumferential direction or the first direction (where for example, the projections are completely staggered), and/or a width of the third slot 233 is greater than a width of the fourth slot 234, and/or more slots are provided on the parasitic stub (where for example, on the parasitic stub 240, a fifth slot is provided on a side that is of the fourth slot 234 and that is away from the feed point). This may reduce the coupling amount due to a small distance. In some embodiments, the fifth slot and the fourth slot 234 may be spaced by 15° to 45° in the circumferential direction.

It should be understood that overlapping in the circumferential direction or overlapping of projections in the circumferential direction is not necessarily overlapping on a same plane. Provided that a first location of the parasitic stub 240 and a second location of the frame 210 overlap at angles in respective ring circumferences, it may be considered that the first location and the second location overlap in the circumferential directions, or the projections in the circumferential directions overlap. Similar understanding should be made for overlapping in the first direction or overlapping of projections in the first direction.

It should be understood that, during actual production or design, relative locations of the fourth slot 234 and the third slot 233 may be adjusted based on an engineering requirement. This is not limited in this embodiment of this application. For example, in an embodiment, both the third slot 233 and the fourth slot 234 are disposed in the areas of the zero current points of the frame in the first band and the second band, and the third slot 233 and the fourth slot 234 are disposed at adjacent locations. For example, the distance between the third slot 233 and the fourth slot 234 is less than 2 mm, or the circumferential distance between the third slot 233 and the fourth slot 234 is less than 2 mm. The circumferential distance between the third slot 233 and the fourth slot 234 may be understood as a circumferential straight-line distance between points on two terminal surfaces of a conductor forming the third slot 233 and points on two terminal surfaces of a conductor forming the fourth slot 234.

In an embodiment, the projection of the first slot 231 on the frame 210 in the circumferential direction or the first direction is located between the first ground point 211 and the second ground point 212 on the first frame part 220.

In an embodiment, the projection of the feed point 201 on the parasitic stub 240 in the circumferential direction or the first direction is located between the second slot 232 and the fourth slot 234 on the first frame part 220.

It should be understood that, relative locations of the first slot 231 or the second slot 232 on the parasitic stub 240 and the first ground point 211 and the second ground point 212 on the frame 210, as well as relative locations of the feed point 201 on the frame 210 and the second slot 232 and the fourth slot 234 on the parasitic stub 240 are adjusted, so that impact of the parasitic stub 240 on current distribution on the frame 210 may be adjusted, and the maximum radiation direction of the radiation pattern generated by the antenna structure in the first band or the maximum radiation direction of the radiation pattern generated by the antenna structure in the second band may be adjusted. In this way, the maximum radiation direction of the radiation pattern generated in the first band is close to the maximum radiation direction of the radiation pattern generated in the second band.

In the foregoing embodiment, an example in which the first slot, the second slot, and the fourth slot are provided on the parasitic stub 240 is used for description. During actual production or application, a quantity of slits may be increased on the parasitic stub 240. As shown in FIG. 8, a plurality of slots are provided, so that the parasitic stub 240 may generate resonances in different bands, to improve efficiency of the antenna structure in different bands.

In an embodiment, an insulating bracket 250 of the wearable device may be further disposed between the parasitic stub 240 and the frame 210, as shown in FIG. 5. In an embodiment, the parasitic stub 240 may be disposed on a surface of the bracket 250. In an embodiment, the parasitic stub 240 may be embedded in the bracket 250.

In an embodiment, the wearable device is a smartwatch, and the bracket 250 may be the watch bezel 141 shown in FIG. 1. In an embodiment, the watch bezel 141 may be made of a non-conductive material, for example, ceramic.

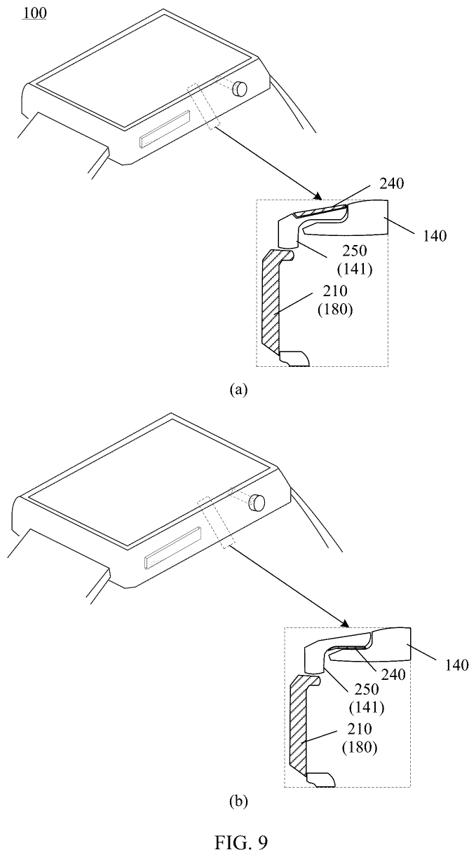

In an embodiment, the parasitic stub 240 may be disposed on a first surface of the bracket 250, and at least a part of the bracket 250 is disposed between the first surface and the frame 210, to ensure that there is a sufficient spacing distance between the parasitic stub 240 and the frame 210, as shown in FIG. 9. In an embodiment, the first surface of the bracket is a surface away from the inside of the wearable device. For example, the parasitic stub 240 is disposed on an outer surface of the wearable device, as shown in (a) in FIG. 9. In an embodiment, a groove is provided on an outer surface of the bracket 250, and the groove may be used to accommodate the parasitic stub 240, so that the parasitic stub 240 is flush with the outer surface and does not protrude, and an appearance of the wearable device has good ornamentality.

In an embodiment, the first surface is a surface close to the inside of the wearable device. For example, the parasitic stub 240 is disposed on an inner surface that is of the bracket and that faces the inside of the device, as shown in (b) in FIG. 9. In an embodiment, the parasitic stub 240 may be disposed between the bracket 250 and the screen 140 (a part that is of the screen 140 and that extends circumferentially to the inside of the wearable device, where the part may be used to fasten the screen).

It should be understood that the foregoing disposition location of the parasitic stub 240 may be implemented by using a technical means such as patching or coating on a surface of the bracket. This is not limited in this embodiment of this application.

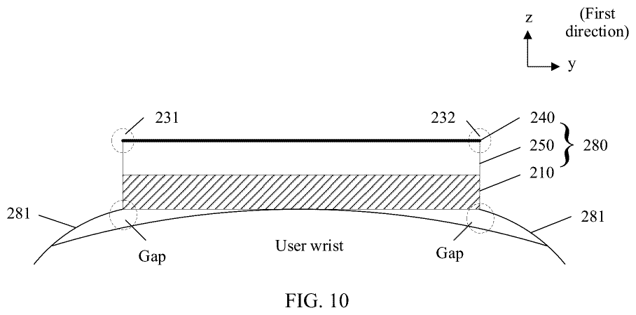

In an embodiment, the frame 210, the watch bezel 250, and the parasitic stub 240 may be a part of a main body 280 of the wearable device, as shown in FIG. 10. The wearable device may further include at least one wrist strap 281. The wrist strap 281 may be connected to the main body 280, and is configured to fasten the main body 280 to a user wrist. The projection, in the first direction, of the first slot 231 or the second slot 232 on the parasitic stub 240 corresponds to a joint between the wrist strap 281 and the main body 280.

It should be understood that, when the user wears the wearable device on the wrist, because the wrist is a curved surface, and a rear cover of the wearable device is a planar structure, the wearable device and the user wrist cannot completely fit, and a gap is generated between the main body 280 and the wrist strap 281. The wrist strap 281 is connected to the main body 280 at a projection of the main body 280 in the first slot 231 or the second slot 232 along the first direction, so that a distance between a strong current point on the parasitic stub and the frame (for example, operating in the first band) and the user wrist may be increased, and an electromagnetic wave, generated by the antenna structure, that is absorbed by the user wrist is reduced, thereby improving the radiation characteristic of the antenna structure.

In an embodiment, the frame 210 may be in a circular ring shape, and an inner diameter of the frame 210 may be between 35 mm and 45 mm. It should be understood that when the frame 210 is in a rectangular ring shape or another ring shape, a circumference range of the frame 210 may be the same as a corresponding circumference range when the frame 210 is in the circular ring shape.

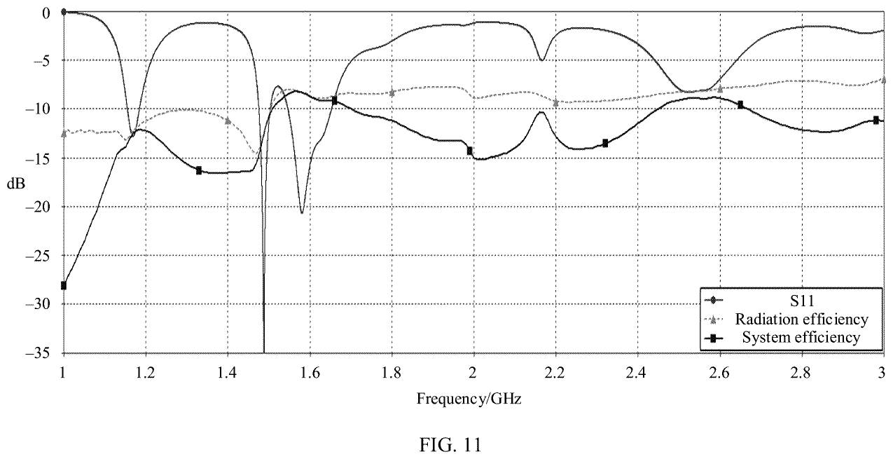

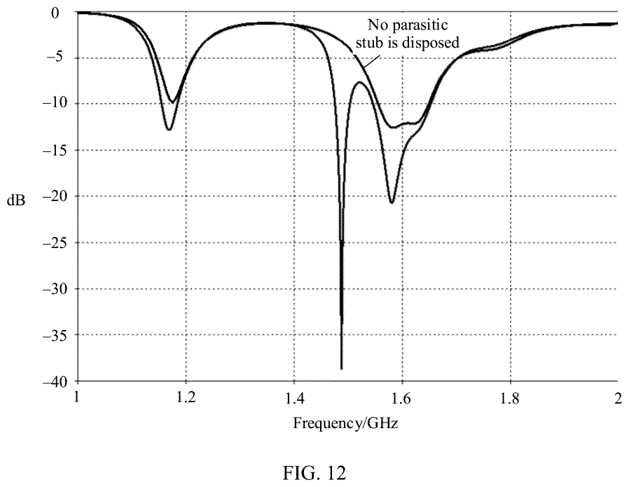

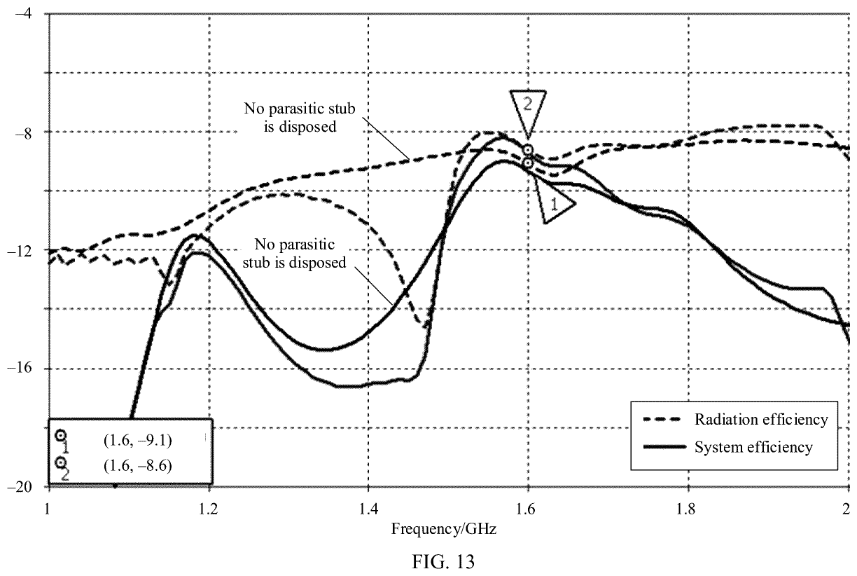

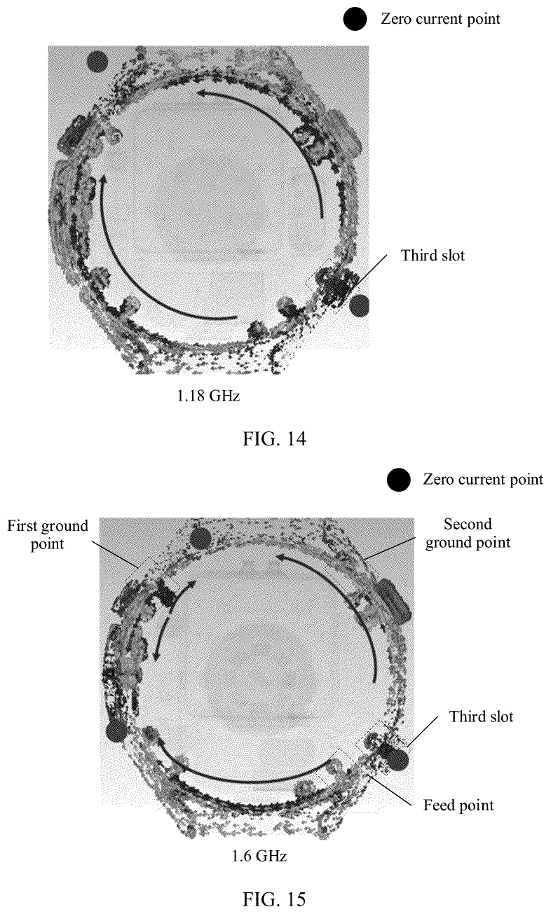

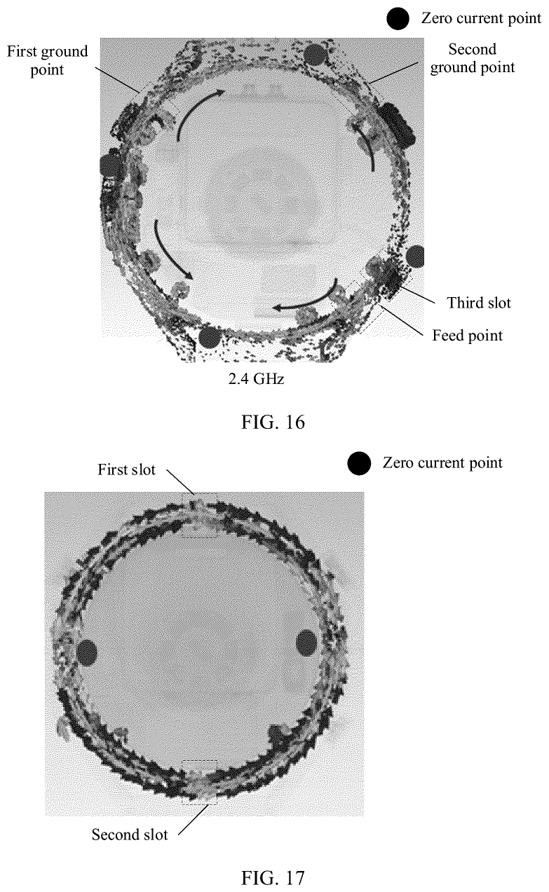

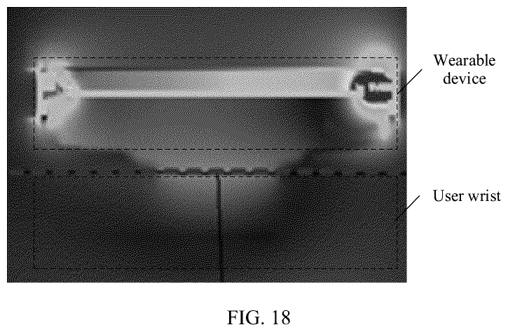

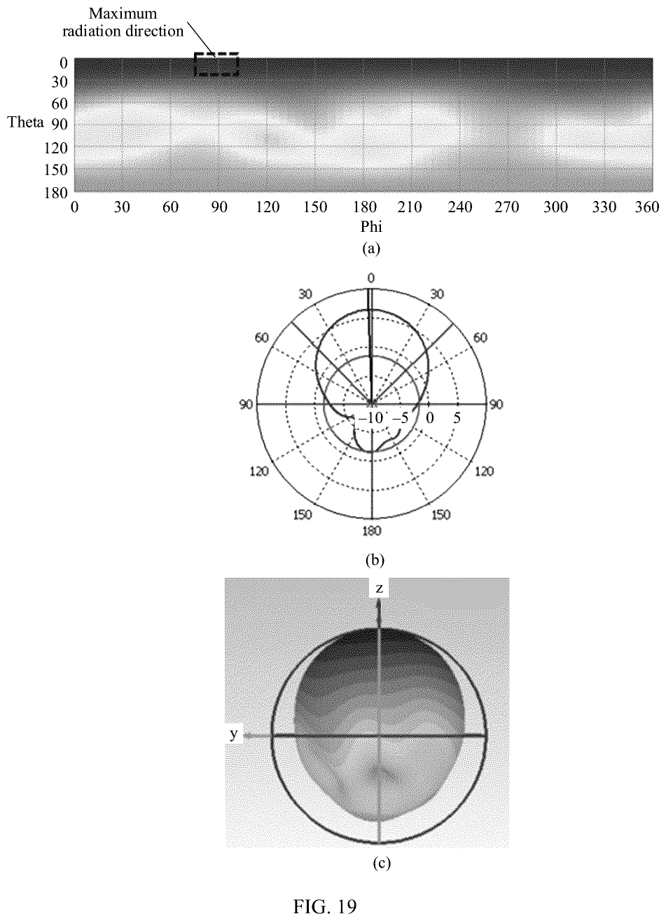

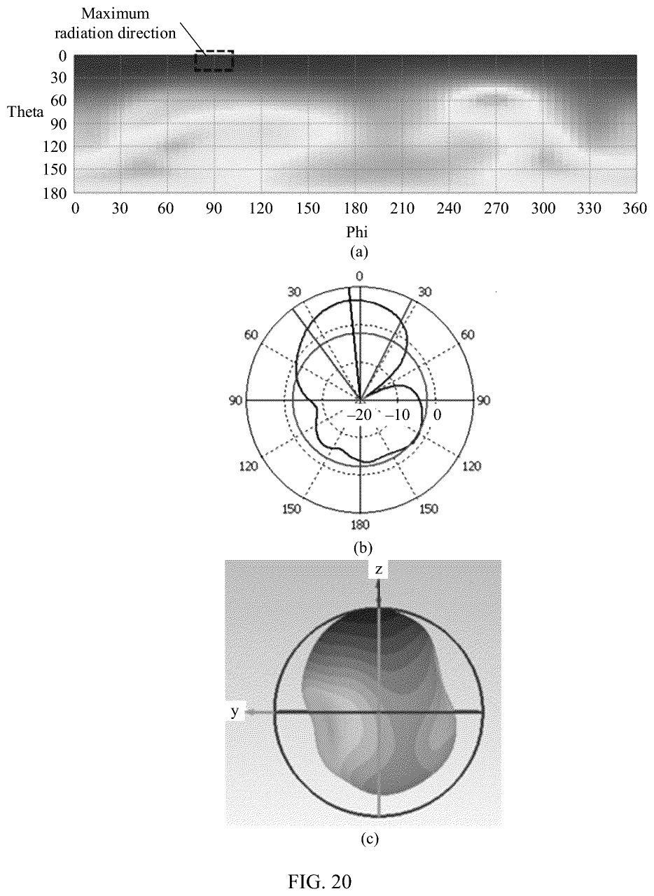

FIG. 11 to FIG. 20 are diagrams of simulation results of the antenna structure shown in FIG. 4. FIG. 11 is a diagram of a simulation result of an S parameter, radiation efficiency, and system efficiency of the antenna structure according to an embodiment of this application. FIG. 12 is an S parameter of the antenna structure in which no parasitic stub is disposed according to an embodiment of this application. FIG. 13 is a diagram of a simulation result of radiation efficiency and system efficiency of the antenna structure in which no parasitic stub is disposed according to an embodiment of this application. FIG. 14 is a diagram of current distribution of the frame at 1.18 GHz according to an embodiment of this application. FIG. 15 is a diagram of current distribution of the frame at 1.6 GHz according to an embodiment of this application. FIG. 16 is a diagram of current distribution of the frame at 2.4 GHz according to an embodiment of this application. FIG. 17 is a diagram of current distribution of the parasitic stub according to an embodiment of this application. FIG. 18 is a diagram of magnetic field distribution of the parasitic stub according to an embodiment of this application. FIG. 19 is a radiation pattern generated by the antenna structure at 1.6 GHz according to an embodiment of this application. FIG. 20 is a radiation pattern generated by the antenna structure at 2.48 GHz according to an embodiment of this application.

As shown in FIG. 11, the operating band of the antenna structure may include an L5band (1176.45±10.23 MHz (1175.427 MHz to 1177.473 MHz)) (which may correspond to the foregoing third band) in the GPS, a transmit band (1610 MHz to 1626.5 MHz) (which may correspond to the foregoing first band) and a receive band (2483.5 MHz to 2500 MHz) (which may correspond to the foregoing second band) in a BeiDou system, and a 2.4G Wi-Fi and BT band.

In addition, both radiation efficiency and system efficiency corresponding to the operating band may meet a communication requirement. For example, in the L5 band in the GPS, the radiation efficiency> −13 dB; in the transmit band in the BeiDou system, the radiation efficiency>-8.8 dB; and in the receive band in the BeiDou system, the radiation efficiency> −9 dB.

As shown in FIG. 12, after the parasitic stub is disposed above the frame, a new resonance (about 1.5 GHz) may be generated by using the parasitic stub. Because the new resonance is generated, efficiency of the antenna structure in an area close to the newly generated resonance (the transmit band (1610 MHz to 1626.5 MHz) in the BeiDou system) is improved by about 0.8 dB, as shown in FIG. 13.

As shown in FIG. 14 to FIG. 16, when an electrical signal is fed into the feed point, at 1.18 GHz, it may be learned from current distribution on the frame that the antenna structure operates in a one-fold wavelength mode, which may correspond to the operating mode of the foregoing third band; at 1.6 GHz, it may be learned from current distribution on the frame that the antenna structure operates in a two-thirds wavelength mode, which may correspond to the operating mode of the foregoing first band; and at 2.4 GHz, it may be learned from current distribution on the frame that the antenna structure operates in a two-fold wavelength mode, which may correspond to the operating mode of the foregoing second band. In the technical solution provided in this embodiment of this application, when the electrical signal is fed into the feed point, the first ground point is disposed between a zero current point generated by the frame in the first band (1.6 GHz) and a zero current point generated by the frame in the second band (2.4 GHz). Because the ground point is usually a large current point (which increases current intensity at a ground location), locations of the two zero current points may be changed between the two zero current points. The second ground point is disposed in an area in which a large current point generated by the frame in the first band (1.6 GHz) is located, and a ground point is disposed in the area in which the large current point is located, so that a location of the large current point is not changed. However, because the second ground point is disposed at the location, a location of the zero current point generated by the frame in the second band (2.4 GHz) is changed, so that the maximum radiation direction of the radiation pattern generated by the antenna structure in the second band is close to the maximum radiation direction of the radiation pattern generated by the antenna structure in the first band. Therefore, relative locations of the feed point and the ground point are controlled, so that a distribution location of the zero current point on the frame may be adjusted, and directivity of the antenna structure may be optimized.

In addition, as shown in FIG. 14 to FIG. 16, in the operating band of the antenna structure, the third slot is disposed in the area of the zero current point on the frame, and a radiation aperture of the antenna structure is increased without affecting current distribution, to reduce impact on the resonance of the antenna structure.

As shown in FIG. 17, when an electrical signal is fed into the feed point, a maximum current point is located in the first slot and the second slot of the parasitic stub, and a zero current point is located between the first slot and the second slot. Therefore, when the wearable device is a smartwatch, the smartwatch is connected to a main body of the smartwatch by using a wrist strap in areas in which the first slot and the second slot are located, so that the first slot and the second slot are far away from a user wrist when the smartwatch is worn, thereby preventing a human body from absorbing the electrical signal generated by the antenna structure, and improving radiation performance of the antenna structure.

As shown in FIG. 18, when the parasitic stub generates the resonance, the first slot and the second slot are provided, so that a strong magnetic field point (a strong current point) generated by the parasitic stub is located in the first slot and the second slot. In addition, a magnetic field direction of the parasitic stub is parallel to the plane on which the parasitic stub is located, and the parasitic stub has a small quantity of z-direction (first direction) components. Therefore, radiation generated by the parasitic stub is less absorbed by the user, and efficiency of the antenna structure is significantly improved.

(a), (b), and (c) shown in FIG. 19 are respectively one-dimensional, two-dimensional, and three-dimensional radiation patterns generated by the antenna structure at 1.6 GHz, and may correspond to transmit bands in the BeiDou satellite system communication technology. The maximum radiation direction of the antenna structure is approximately a thickness direction (the first direction), and a gain of the antenna structure is greater than 6.3 dBi.

(a), (b), and (c) shown in FIG. 20 are respectively one-dimensional, two-dimensional, and three-dimensional radiation patterns generated by the antenna structure at 2.48 GHz, and may correspond to receive bands in the BeiDou satellite system communication technology. The maximum radiation direction of the antenna structure is approximately a thickness direction (the first direction), and a gain of the antenna structure is greater than 6.4 dBi.

Therefore, for the transmit band and the receive band in the BeiDou satellite system communication technology, the maximum radiation directions of the radiation patterns generated by the antenna structure are basically the same, to meet a requirement for angle alignment, so that accuracy of transmitting a short message may be improved.

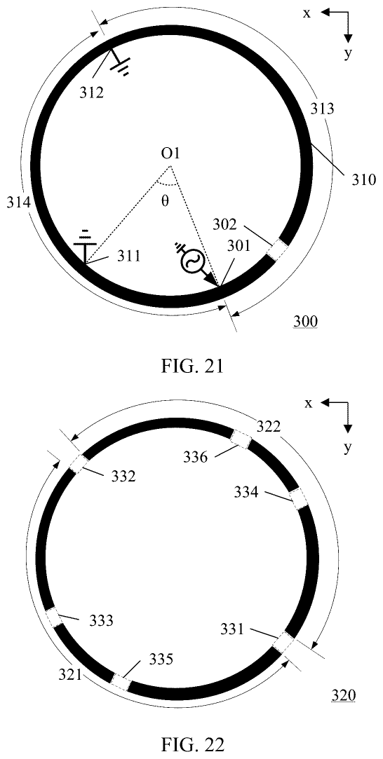

FIG. 21 is a diagram of a structure of an antenna structure 300 according to an embodiment of this application. The antenna structure 300 may be applied to the wearable device 100 shown in FIG. 1.

It should be understood that the antenna structure 300 shown in FIG. 21 is similar to the antenna structure 200 shown in FIG. 4. The antenna structure 300 includes a conductive frame 310, and the frame 310 may be the metal frame 180 in FIG. 1. The frame 310 may be in a ring shape, for example, in a circular ring shape, a rectangular ring shape, or another ring shape.

In an embodiment, a first ground point 311 and a feed point 301 are disposed on the frame 310. The frame 310 is grounded at the first ground point 311, and is electrically connected to a ground plate. The feed point 301 is configured to feed an electrical signal into the antenna structure 300.

In an embodiment, an angle between the first ground point 311 and the feed point 301 is greater than or equal to 60° and less than or equal to 108°.

In an embodiment, the angle between the first ground point 311 and the feed point 301 in a ring circumference may be understood as an angle θ between a connection line of a geometric center O1 of a graph encircled by the first ground point 311 and the frame 310 and a connection line between the feed point 301 and the geometric center O1. For example, when the frame 310 is in a circular ring shape, the geometric center O1 is a center of the ring. When the frame 310 is in a rectangular ring shape, the geometric circle O1 is an intersection point of two diagonals of a rectangle. In the following embodiments, an angle between slots may also be understood as an angle between connection lines between centers of two slots and the geometric center O1.

As shown in FIG. 22, the antenna structure 300 may further include a parasitic stub 320. The parasitic stub 320 may be in a ring shape, for example, in a circular ring shape, a rectangular ring shape, or another ring shape. In an embodiment, both the frame 310 and the parasitic stub 320 are in a circular ring shape. In an embodiment, both the frame 310 and the parasitic stub 320 are in a rectangular ring shape. In an embodiment, both the frame 310 and the parasitic stub 320 are in a square ring shape.

In an embodiment, the parasitic stub 320 and the frame 310 are spaced in ring circumferences. In an embodiment, the parasitic stub 320 and the frame 310 are not in contact with each other in respective ring circumferences.

In an embodiment, the parasitic stub 320 and the frame 310 may be concentric rings that do not contact with each other. The concentric ring may be understood based on the foregoing descriptions.

In an embodiment, the parasitic stub 320 is located above the frame 310 in a first direction (where when being worn, the parasitic stub 320 is on a side away from a user). For a location relationship (a stacking relationship) between the parasitic stub 320 and the frame 310, refer to related descriptions (for example, the location relationship shown in (a) and (b) in FIG. 5) in the foregoing embodiment. In an embodiment, the first direction is a direction perpendicular to a plane on which the parasitic stub 320 is located. In an embodiment, the first direction may be understood as a thickness direction of the wearable device.

As shown in FIG. 22, the parasitic stub 320 may include a first slot 331 and a second slot 332. The parasitic stub 320 is divided into a first parasitic part 321 and a second parasitic part 322 by the first slot 331 and the second slot 332. A length Li of a parasitic stub 320 of the first parasitic part 321 is the same as a length L2 of a parasitic stub 320 of the second parasitic part 322. During actual engineering application, based on a layout inside the wearable device, the length L1 of the parasitic stub 320 of the first parasitic part 321 and the length L2 of the parasitic stub 320 of the second parasitic part 322 may have an offset. Therefore, when the length L1 of the parasitic stub 320 of the first parasitic part 321 and the length L2 of the parasitic stub 320 of the second parasitic part 322 meet: (100%−10%)×L1≤L2≤(100%+10%)×L1, it may be considered that (100%−10%)×L1≤L2≤(100%+10%)×L1 is the same.

In an embodiment, the feed point 301 may be located between the first ground point 311 and a projection of the first slot 331 on the frame 310.

In an embodiment, an operating band of the antenna structure 300 may include a first band, a second band, and a third band, a frequency of the first band is lower than a frequency of the second band, and the frequency of the second band is lower than a frequency of the third band. In an embodiment, a resonance band generated by a one-fold wavelength mode of the frame 310 may include the first band, a resonance band generated by a two-thirds wavelength mode of the frame 310 may include the second band, and a resonance band generated by a two-fold wavelength mode of the frame 310 may include the third band. In an embodiment, the first band may include an L5 band (1176.45 MHz±10.23 MHz) in a GPS. The second band may include a transmit band of a BeiDou satellite system communication band, for example, 1610 MHz to 1626.5 MHz (an L band). The third band may include a receive band of the BeiDou satellite system communication band, for example, 2483.5 MHz to 2500 MHz (an S band).

It should be understood that, in the technical solution of this embodiment of this application, the parasitic stub that is spaced from a radiator (the frame) and that is not in contact with the radiator is disposed in the antenna structure, and the parasitic stub may generate an additional resonance by using energy coupled to the parasitic stub when the radiator is resonant, so that performance (for example, efficiency and bandwidth) of the antenna structure may be extended.

It should be understood that, in the technical solution provided in this embodiment of this application, locations of the first ground point and the feed point are used, so that the ground point is usually a large current point (which increases current intensity at a ground location). Grounding at the first ground point may change locations of zero current points generated in the second band and the third band on two sides of the frame, and current distribution of the frame in the second band and the third band is adjusted. In this way, a maximum radiation direction of a radiation pattern generated in the second band is close to a maximum radiation direction of a radiation pattern generated in the third band, and the second band and the third band meet a requirement for angle alignment (where for example, an angle difference between the maximum radiation direction of the radiation pattern generated in the second band and the maximum radiation direction of the radiation pattern generated in the third band is less than or equal to) 30°. In an embodiment, based on a location relationship between the first ground point and the feed point, the antenna structure may have a good polarization characteristic (for example, right-hand circular polarization) in the first band, and a receive gain of the antenna structure for a polarized electrical signal in the first band is improved, thereby improving communication performance of the wearable device.

In an embodiment, the operating band of the antenna structure 300 may include a part of bands in a cellular network. In an embodiment, the feed point 301 may be further configured to feed an electrical signal in at least one band of B5 (824 MHz to 849 MHz), B8 (890 MHz to 915 MHz), and B28 (704 MHz to 747 MHz).

In an embodiment, the parasitic stub 320 further has a third slot 333 and a fourth slot 334. The third slot 333 may be located in the first parasitic part 321, and the fourth slot 334 may be located in the second parasitic part 322. An angle between the third slot 333 and the second slot 332 is greater than or equal to 55° and less than or equal to 70°. Correspondingly, an angle between the fourth slot 334 and the first slot 331 is greater than or equal to 55° and less than or equal to 70°. The parasitic stub 320 is divided into a third parasitic part and a fourth parasitic part by the third slot 333 and the fourth slot 334, and a length L3 of the third parasitic part and a length L4 of the fourth parasitic part meet: (100%31 10%)×L3≤L4≤(100%+10%)×L3.

In an embodiment, the parasitic stub 320 further has a fifth slot 335 and a sixth slot 336. The fifth slot is located between the first slot 331 and the third slot 333, and the sixth slot 336 is located between the second slot 332 and the fourth slot 334. An angle between the fifth slot 335 and the third slot 333 is greater than or equal to 35° and less than or equal to 45°. The parasitic stub 320 is divided into a fifth parasitic part and a sixth parasitic part by the fifth slot 335 and the sixth slot 336, and a length L5 of the fifth parasitic part and a length L6 of the sixth parasitic part meet: (100%−10%)×L5≤L6≤(100%+10%)×L5.

It should be understood that a plurality of slots are provided on the parasitic stub 320, so that a radiation aperture of the antenna structure may be increased, and efficiency of the antenna structure may be improved. In addition, directivity of radiation generated by the antenna structure may be adjusted by using a current generated by coupling on the parasitic stub 320 to affect current distribution on the frame 310 (for example, the maximum radiation direction of the radiation pattern generated in the second band or the maximum radiation direction of the radiation pattern generated in the third band). In addition, the plurality of slots are provided on the parasitic stub 320, so that the parasitic stub 320 may operate in a higher-order operating mode. For example, as a quantity of slots provided on the parasitic stub 320 increases, a resonance generated by the parasitic stub 320 shifts to a high frequency. For example, when six slots are provided on the parasitic stub 320, the operating mode of the parasitic stub 320 may be a two-fold wavelength mode. When the resonance generated in this mode is close to the third band, efficiency of the third band may be increased.

In an embodiment, a first resonance generated by the frame 310 and a second resonance generated by the parasitic stub 320 may jointly operate in the operating band of the antenna structure, and the operating band may include the third band.

In an embodiment, that a first resonance generated by the frame 310 and a second resonance generated by the parasitic stub 320 jointly operate in the operating band of the antenna structure may be understood that the first resonance generated by the frame 310 operates in the operating band of the antenna structure, and the second resonance generated by the parasitic stub 320 may be used to improve efficiency of the antenna structure in the operating band. For example, at least a part of the resonance generated by the parasitic stub 320 falls within the operating band. In an embodiment, a part of an S11 curve of the resonance generated by the parasitic stub 320 below a first threshold (for example, −4 dB) at least partially overlaps the operating band. It should be understood that a center frequency of the resonance generated by the parasitic stub 320 may be in the operating band or outside the operating band. It should be understood that a frequency of the resonance generated by the parasitic stub 320 may be a resonance generated by the adjacent frame 310 in the third band, to extend bandwidth of the frame 310 in the band, and improve efficiency of the band.

In an embodiment, a frequency of the first resonance may be greater than a frequency of the second resonance. In an embodiment, a difference between the frequency of the first resonance and the frequency of the second resonance is greater than or equal to 10 MHz and less than or equal to 100 MHz. It should be understood that the frequency of the resonance (the second resonance) generated by the parasitic stub 320 is slightly lower than the frequency of the resonance (the first resonance) generated by the frame 310, so that efficiency of the antenna structure in the third band may be better improved. The difference between the frequency of the first resonance and the frequency of the second resonance may be understood as a difference between a frequency of a resonance point of the first resonance and a frequency of a resonance point of the second resonance.

In an embodiment, a size of the parasitic stub 240 may be approximately the same as a size of the frame 210. In an embodiment, an outer diameter R3 of the parasitic stub 240 may be less than an outer diameter R1 of the frame 210 and greater than an inner diameter R2 of the frame 210.

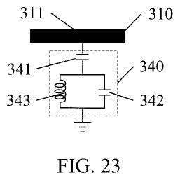

In an embodiment, the antenna structure 300 may further include a filter circuit 340, as shown in FIG. 23. The filter circuit 340 is electrically connected between the frame 310 and a ground plate at the first ground point 311. The filter circuit 340 may be a high-pass low-impedance filter circuit. For example, the filter circuit 340 is in a turned-off state in the first band, so that the frame 310 is not electrically connected to the ground plate at the first ground point 311; and is in a turned-on state in the second band and the third band, so that the frame 310 is electrically connected to the ground plate at the first ground point 311.

In an embodiment, the filter circuit 340 may include a first capacitor 341, a second capacitor 342, and an inductor 343. A first terminal of the first capacitor 341 is electrically connected to the frame 310 at the first ground point 311, a second terminal of the first capacitor 341 is electrically connected to a first terminal of the second capacitor 342 and a first terminal of the inductor 343, and a second terminal of the second capacitor 342 and a second terminal of the inductor 343 are grounded. It should be understood that the filter circuit shown in FIG. 23 is merely an example. A specific form of the filter circuit 340 is not limited in this embodiment of this application, and may be selected based on an actual layout inside the wearable device.

In an embodiment, a seventh slot 302 is provided on the frame 310. The feed point 301 may be located between the seventh slot 302 and the first ground point 311.

It should be understood that the seventh slot 302 is provided on the frame 310, so that a radiation aperture of the antenna structure 300 may be increased, thereby improving efficiency of the antenna structure 200.

In an embodiment, a distance between the seventh slot 302 and the feed point 301 may be within a range of 1 mm to 6 mm. In an embodiment, a distance between the seventh slot 302 and the feed point 301 may be within a range of 2 mm to 5 mm.

It should be understood that, a location of the seventh slot 302 is adjusted, so that when an electrical signal is fed into the feed point 301, the seventh slot 302 may be located in an area of a zero current point (an area in which an electric field point is strong) generated by the frame 310. Because the seventh slot 302 is located in the area of the zero current point, in comparison with a case in which the seventh slot 302 is not added, that the seventh slot 302 is provided does not affect current distribution of the antenna structure 300, and therefore does not affect a radiation characteristic of the antenna structure 300.

In an embodiment, for a location relationship between the first slot 331 and the seventh slot 302 on the parasitic stub 320, refer to the location relationship between the fourth slot 234 and the third slot 233 in the foregoing embodiment.

In an embodiment, a first location 312 may be further disposed on the frame 310. The frame 310 is divided into a first frame part 313 and a second frame part 314 by the first location 312 and the feed point 301, and a length D1 of the first frame part 313 and a length D2 of the second frame part 314 meet: (100%−10%)×D1≤D2≤(100%+10%)×D1. In an embodiment, the first ground point 311 may be disposed on the second frame part 314. In an embodiment, the seventh slot 302 may be disposed on the first frame part 313.

In an embodiment, the first location 312 may be used as a second ground point, and the frame 310 is directly connected to the ground plate at the first location 312 (where no filter circuit is disposed between the first location 312 and the ground plate). It should be understood that, when the first location 312 is used as the second ground point, the maximum radiation direction of the radiation pattern generated by the antenna structure 300 in the second band may be further close to the maximum radiation direction of the radiation pattern generated by the third band, and the second band and the third band meet a requirement for angle alignment (where for example, an angle difference between the maximum radiation direction of the radiation pattern generated in the second band and the maximum radiation direction of the radiation pattern generated in the third band is less than or equal to) 30°. Alternatively, in an embodiment, a low-pass high-impedance filter circuit may be electrically connected between the first location 312 and the ground plate. The filter circuit may be in a turned-on state in the first band and the second band, so that the frame 310 is electrically connected to the ground plate; and is in a turned-off state in the third band, so that the frame 310 is not electrically connected to the ground plate. It should be understood that, when a low-pass high-impedance filter circuit is electrically connected between the first location 312 and the ground plate, performance (for example, directivity) of the antenna structure 300 in the first band and the second band may be improved.

In an embodiment, the first location 312 may be used as the feed point, the frame 310 feeds the electrical signal at the first location 312, and a band corresponding to the generated resonance may include at least a part of frequency bands in an ultra-wideband (UWB) (3.1 GHz to 10.6 GHz). It should be understood that a communication band of the antenna structure 300 may be extended by feeding the electrical signal corresponding to the UWB at the first location 312.

In an embodiment, the antenna structure may further include a switch. A common terminal of the switch may be electrically connected to the frame 310 at the first location 312, a first terminal may be electrically connected to the ground plate, and a second terminal may be electrically connected to a feed unit to feed the electrical signal. It should be understood that an electrical connection state of the frame 310 at the first location 312 may be switched by switching an electrical connection state between the common terminal of the switch and the first terminal or the second terminal, to change a part of functions of the antenna structure 300.

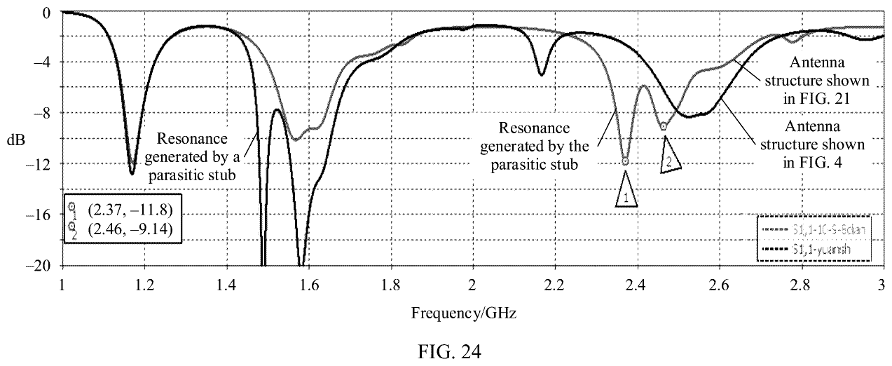

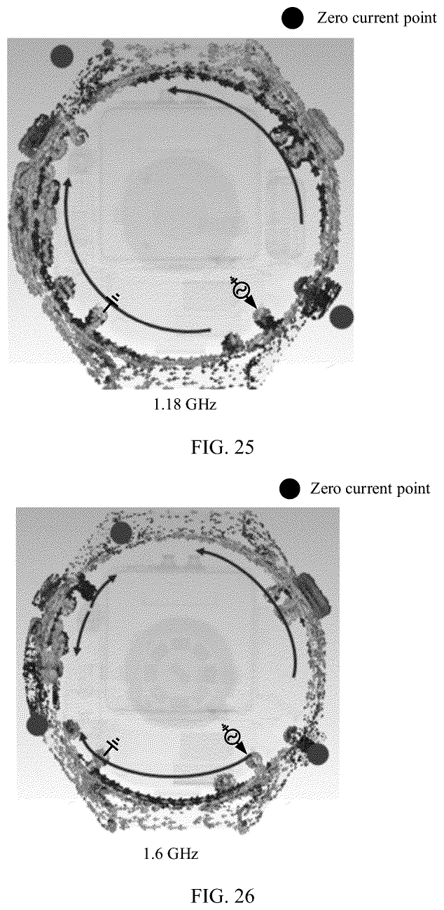

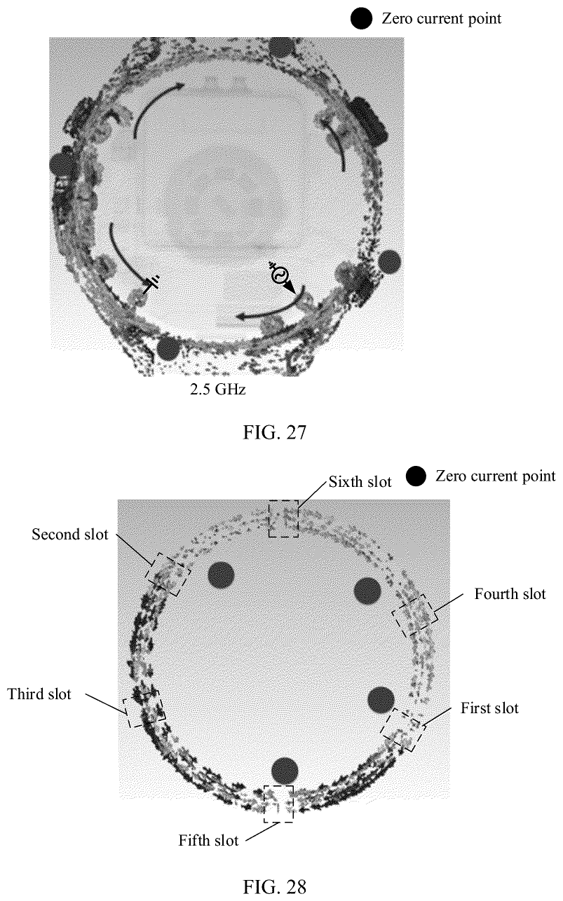

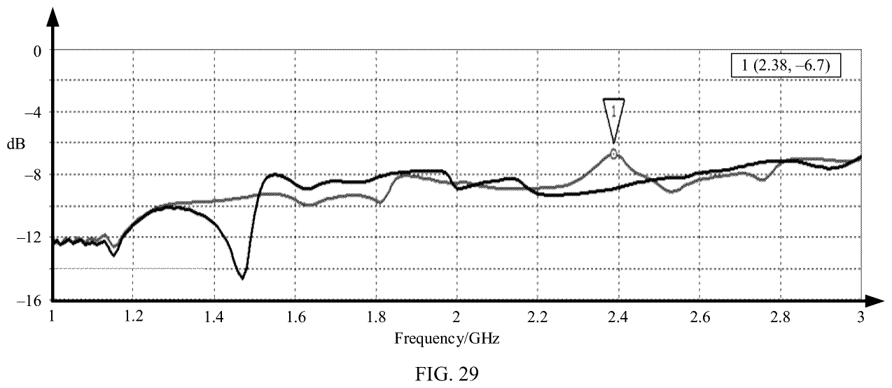

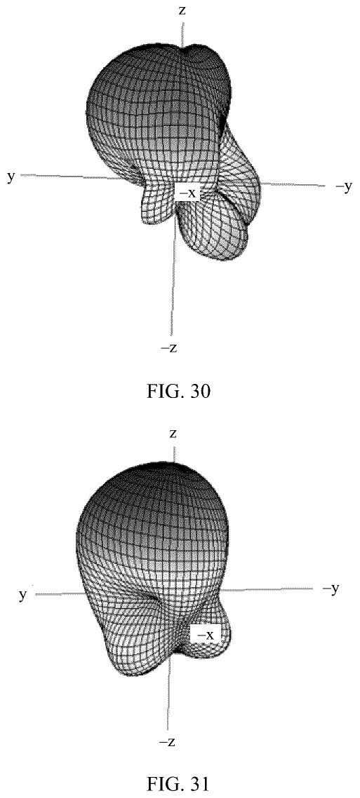

FIG. 24 to FIG. 31 are diagrams of simulation results of the antenna structure shown in FIG. 21. FIG. 24 is a diagram of a simulation result of an S parameter of the antenna structure according to an embodiment of this application. FIG. 25 is a diagram of current distribution of the frame at 1.18 GHz according to an embodiment of this application. FIG. 26 is a diagram of current distribution of the frame at 1.6 GHz according to an embodiment of this application. FIG. 27 is a diagram of current distribution of the frame at 2.5 GHz according to an embodiment of this application. FIG. 28 is a diagram of current distribution of the parasitic stub according to an embodiment of this application. FIG. 29 is a simulation result of radiation efficiency according to an embodiment of this application. FIG. 30 is a radiation pattern generated by the antenna structure at 1.6 GHz according to an embodiment of this application. FIG. 31 is a radiation pattern generated by the antenna structure at 2.48 GHz according to an embodiment of this application.

As shown in FIG. 24, the operating band of the antenna structure may include an L5 band (1176.45±10.23 MHz) (the first band) in the GPS, a transmit band (1610 MHz to 1626.5MHz) (the second band) and a receive band (2483.5 MHz to 2500 MHz) in a BeiDou system, and a 2.4G Wi-Fi and BT band (the third band).

FIG. 25 shows current distribution of the frame in the first band (for example, 1.18 GHz). It may be learned from the current distribution of the frame that the antenna structure operates in a one-fold wavelength mode. FIG. 26 shows current distribution of the frame in the second band (for example, 1.6 GHz). It may be learned from the current distribution of the frame that the antenna structure operates in a two-thirds wavelength mode. FIG. 27 shows current distribution of the frame in the third band (for example, 2.5 GHz). It may be learned from the current distribution of the frame that the antenna structure operates in a two-fold wavelength mode. In the technical solution provided in this embodiment of this application, grounding at first ground point may change locations of zero current points originally generated in the second band and the third band on two sides of the frame, and current distribution of the frame in the second band and the third band is adjusted. In this way, the maximum radiation direction of the radiation pattern generated in the second band is close to the maximum radiation direction of the radiation pattern generated in the third band, and the second band and the third band meet the requirement for angle alignment (where for example, the angle difference between the maximum radiation direction of the radiation pattern generated in the second band and the maximum radiation direction of the radiation pattern generated in the third band is less than or equal to) 30°. Therefore, relative locations of the feed point and the ground point are controlled, so that a distribution location of the zero current point on the frame may be adjusted, and directivity of the antenna structure may be optimized.

As shown in FIG. 28, in comparison with the antenna structure shown in FIG. 4, after six slots are provided on the parasitic stub, the operating mode of the parasitic stub is changed from a one-fold wavelength mode (current distribution shown in FIG. 17) to a two-fold wavelength mode (current distribution shown in FIG. 28). A resonance frequency of the parasitic stub is increased to 2.37 GHz shown by a mark 1 in FIG. 24, and is adjacent to a resonance point (2.46 GHz shown by the mark 1 in FIG. 24) generated in a two-thirds wavelength mode (where a frequency difference is greater than or equal to 10 MHz and less than or equal to 100 MHz).

It should be understood that, when the resonance frequency of the parasitic stub is close to the resonance point generated in the two-thirds wavelength mode, the resonance frequency of the parasitic stub may be used to improve efficiency of the antenna structure in the third band. As shown in FIG. 29, in comparison with the antenna structure shown in FIG. 4, the antenna structure may be improved by about 2 dB.

FIG. 30 is a three-dimensional radiation pattern generated by the antenna structure at 1.6 GHz, and the radiation pattern may correspond to a transmit band in the BeiDou satellite system communication technology. The maximum radiation direction of the antenna structure is approximately a thickness direction (the first direction), and a gain of the antenna structure is approximately −3.62 dBi.

FIG. 31 is a three-dimensional radiation pattern generated by the antenna structure at 2.48 GHz, and the radiation pattern may correspond to a receive band in the BeiDou satellite system communication technology. The maximum radiation direction of the antenna structure is approximately a thickness direction (the first direction), and a gain of the antenna structure is approximately 3.58 dBi.

Therefore, for the transmit band and the receive band in the BeiDou satellite system communication technology, the maximum radiation directions of the radiation patterns generated by the antenna structure are basically the same, to meet the requirement for angle alignment, so that accuracy of transmitting a short message may be improved.

In the several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical or another form.

The foregoing descriptions are merely specific implementations of this application, and are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wearable device, comprising:
a conductive frame having a first ground point and a feed point disposed thereon, wherein the first ground point is configured to ground the conductive frame; and
a parasitic stub having a first slot and a second slot, wherein the parasitic stub and the conductive frame each have a ring shape and are spaced along a ring circumference, wherein
the parasitic stub is divided into a first parasitic part and a second parasitic part by the first slot and the second slot, and
a length L4 of the first parasitic part and a length L5 of the second parasitic part satisfy: (100%−10%)×L4≤L5≤(100%+10%)×L4.

2. The wearable device according to claim 1, wherein:
the conductive frame is divided into a first frame part and a second frame part by the first ground point and the feed point; and
a length L1 of the first frame part and a length L2 of the second frame part satisfy: (100%−10%)×L1≤L2≤(100%+10%)×L1.

3. The wearable device according to claim 1, wherein:
the feed point is configured to feed the conductive frame; and
the conductive frame and the parasitic stub are configured to generate radiation in a first band.

4. The wearable device according to claim 3, wherein:
the conductive frame is further configured to generate radiation in a second band, and a frequency of the first band is lower than a frequency of the second band; and
an angle difference between a maximum radiation direction of a radiation pattern generated by the wearable device in the first band and a maximum radiation direction of a radiation pattern generated by the wearable device in the second band is less than or equal to 30°.

5. The wearable device according to claim 2, further comprising a second ground point disposed on the conductive frame, wherein:
the second ground point is disposed on the first frame part; and
a length L3 of a third frame part between the first ground point and the second ground point and the length L1 of the first frame part satisfy: (33%−10%)×L1≤L3≤(33%+10%)×L1, and the first frame part comprises the third frame part.

6. The wearable device according to claim 2, further comprising a second ground point disposed on the conductive frame, wherein:
the second ground point is disposed on the first frame part; and
a third slot is provided on the conductive frame, and the third slot is located between the second ground point and the feed point on the first frame part.

7. The wearable device according to claim 6, wherein:
a fourth slot is provided on the first parasitic part; and
a projection of the fourth slot on the conductive frame at least partially overlaps a projection of the third slot on the conductive frame, or
projection of the fourth slot on the conductive frame and a projection of the third slot on the conductive frame are at least partially non-overlapping, and the third slot on the first frame part is at least partially located between the feed point and the projection of the fourth slot on the first frame part.

8. The wearable device according to claim 2, further comprising a second ground point disposed on the conductive frame, wherein:
the second ground point is disposed on the first frame part; and
a projection of the first slot on the conductive frame is located between the first ground point and the second ground point on the first frame part.

9. The wearable device according to claim 7, wherein a projection of the feed point on the parasitic stub is located between the second slot and the fourth slot on the first parasitic part.

10. The wearable device according to claim 1, wherein an angle between the first ground point and the feed point in a ring circumference is greater than or equal to 60° and less than or equal to 108°.

11. The wearable device according to claim 10, wherein:
the parasitic stub further has a third slot and a fourth slot;
the parasitic stub is divided into a third parasitic part and a fourth parasitic part by the third slot and the fourth slot; and
a length L3 of the third parasitic part and a length L4 of the fourth parasitic part satisfy: (100%−10%)×L3≤L4≤(100%+10%)×L3, and an angle between the third slot and the second slot in a ring circumference is greater than or equal to 55° and less than or equal to 70°.

12. The wearable device according to claim 11, wherein:
the parasitic stub further has a fifth slot and a sixth slot;
the parasitic stub is divided into a fifth parasitic part and a sixth parasitic part by the fifth slot and the sixth slot; and
a length L5 of the fifth parasitic part and a length L6 of the sixth parasitic part satisfy: (100%−10%)×L5≤L6≤(100%+10%)×L5, the fifth slot is located between the first slot and the third slot, and an angle between the fifth slot and the third slot in a ring circumference is greater than or equal to 35° and less than or equal to 45°.

13. The wearable device according to claim 10, wherein the feed point is located between the first ground point and a projection of the first slot on the conductive frame.

14. The wearable device according to claim 10, wherein:
the feed point is configured to feed the conductive frame;
the conductive frame is configured to generate radiation in a first band and a second band;
the conductive frame and the parasitic stub are configured to generate radiation in a third band;
a frequency of the first band is lower than a frequency of the second band; and
the frequency of the second band is lower than a frequency of the third band.

15. The wearable device according to claim 14, wherein a first resonance generated by the conductive frame and a second resonance generated by the parasitic stub are used to generate radiation in the third band.

16. The wearable device according to claim 15, wherein a frequency of the first resonance is greater than a frequency of the second resonance.

17. The wearable device according to claim 16, wherein a difference between the frequency of the first resonance and the frequency of the second resonance is greater than or equal to 10 MHz and less than or equal to 100 MHz.

18. The wearable device according to claim 10, further comprising a second ground point disposed on the conductive frame, wherein:
the conductive frame is divided into a first frame part and a second frame part by the second ground point and the feed point, and the first ground point is disposed on the first frame part; and
a length D1 of the first frame part and a length D2 of the second frame part satisfy: (100%−10%)×D1≤D2≤(100%+10%)×D1.

19. The wearable device according to claim 1, wherein:
the wearable device is a smartwatch;
the wearable device further comprises an insulating watch bezel; and
the parasitic stub is disposed on a first surface of the watch bezel, and at least a part of the watch bezel is located between the parasitic stub and the conductive frame.

20. The wearable device according to claim 19, wherein:
the wearable device further comprises a main body and at least one wrist strap;
the main body comprises the conductive frame, a bracket, and the parasitic stub;
the at least one wrist strap is connected to the main body; and
a projection of the first slot or a projection of the second slot on the conductive frame corresponds to a connection joint between the at least one wrist strap and the main body.
